(19) United States
(12) Patent Application Publication
(10) Pub. No.: US 2024/0267859 A1
(43) Pub. Date: Aug. 8, 2024

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Teng MA, Dongguan (CN); Zhenshan ZHAO, Dongguan (CN); Zuomin WU, Dongguan (CN)

(21) Appl. No.: 18/635,324

(22) Filed: Apr. 15, 2024

Related U.S. Application Data
(63) Continuation of application No. PCT/CN2021/125918, filed on Oct. 22, 2021.

(51) Int. Cl. H04W 56/00; H04W 74/0808; H04W 92/18

(52) U.S. Cl. CPC H04W 56/001; H04W 74/0808; H04W 92/18

(57) ABSTRACT

There is provided a wireless communication, a terminal device and a network device. A terminal device determines a synchronization resource of a sidelink, where the synchronization resource includes N synchronization slots, and N is a positive integer. The terminal device sends, according to a result of performing channel access on the synchronization resource, a synchronization signal by occupying at least part of synchronization slots among the N synchronization slots.

### CROSS-REFERENCE TO RELATED APPLICATION

This is a continuation application of International Patent Application No. PCT/CN2021/125918 filed on Oct. 22, 2021, the content of which is incorporated by reference in its entirety.

### BACKGROUND

In the New Radio-Vehicle to Everything (NR-V2X), synchronization transmission resources and sidelink data transmission resources in the sidelink transmission are Time Division Multiplexing (TDM). Moreover, a synchronization resource for transmitting a synchronization signal is not included in a resource pool for sidelink data transmission. In addition, the terminal needs to send and receive the sidelink synchronization signal on different time-domain resources. Generally, configuration of two or three sets of synchronization resources are supported within each synchronization period, and each set of synchronization resources includes multiple transmission opportunities to send or receive the synchronization signal, so as to improve detection performance of the terminal device.

In the NR-V2X communication system, there are many terminals sending synchronization signals, so there may be multiple terminals sending the synchronization signals on each synchronization resource in the sidelink transmission. In this case, how the terminals send the synchronization signals on the synchronization resources is a problem that needs to be solved.

### SUMMARY

Embodiments of the present disclosure relate to the field of communications. Embodiments of the present disclosure provide a method for wireless communication, a terminal device and a network device, which supports multiple terminal devices to send synchronization signals on a synchronization resource, improves reliability and completeness of a synchronization mechanism of a sidelink, and improves system performance.

In a first aspect, there is provided a method for wireless communication including that: a terminal device determines a synchronization resource of a sidelink, where the synchronization resource includes N synchronization slots, and N is a positive integer; and the terminal device sends, according to a result of performing channel access on the synchronization resource, a synchronization signal by occupying at least part of synchronization slots among the N synchronization slots.

In a second aspect, there is provided a method for wireless communication including that: a network device sends configuration information to a terminal device, where the configuration information is used for configuring the terminal device to send a synchronization signal by occupying at least part of synchronization slots among N synchronization slots in a synchronization resource, where N is a positive integer.

In a third aspect, there is provided a terminal device including a processor and a transceiver, where the processor and the transceiver cooperates to perform the method in the first aspect.

In a fourth aspect, there is provided a network device including a processor and a transceiver, where the processor and the transceiver cooperates to perform the method in the second aspect.

### BRIEF DESCRIPTION OF THE DRAWINGS

FIG. 1 is a schematic diagram of a communication system architecture to which embodiments of the present disclosure are applied.

FIG. 2 is another schematic diagram of a communication system architecture to which embodiments of the present disclosure are applied.

FIG. 3 is a schematic diagram of sidelink communication within a network coverage according to the present disclosure.

FIG. 4 is a schematic diagram of sidelink communication partly within a network coverage according to the present disclosure.

FIG. 5 is a schematic diagram of sidelink communication outside a network coverage according to the present disclosure.

FIG. 6 is a schematic diagram of unicast sidelink communication according to the present disclosure.

FIG. 7 is a schematic diagram of multicast sidelink communication according to the present disclosure.

FIG. 8 is a schematic diagram of broadcast sidelink communication according to the present disclosure.

FIG. 9 is a schematic diagram of a sensing-based resource selection according to the present disclosure.

FIG. 10 is a schematic diagram of channel occupancy according to the present disclosure.

FIG. 11 is a schematic diagram of a channel access manner of Frame based equipment (FBE) according to the present disclosure.

FIG. 12 is a schematic diagram of a channel access type handover according to the present disclosure.

FIG. 13 is a schematic diagram of synchronization resources according to the present disclosure.

FIG. 14 is another schematic diagram of synchronization resources according to the present disclosure.

FIG. 15 is yet another schematic diagram of synchronization resources according to the present disclosure.

FIG. 16 is a schematic flowchart of a method for wireless communication according to an embodiment of the present disclosure.

FIG. 17 is a specific schematic diagram of sending a synchronization signal according to an embodiment of the present disclosure.

FIG. 18 is another specific schematic diagram of sending a synchronization signal according to an embodiment of the present disclosure.

FIG. 19 is another specific schematic diagram of sending a synchronization signal according to an embodiment of the present disclosure.

FIG. 20 is another specific schematic diagram of sending a synchronization signal according to an embodiment of the present disclosure.

FIG. 21 is another specific schematic diagram of sending a synchronization signal according to an embodiment of the present disclosure.

FIG. 22 is another specific schematic diagram of sending a synchronization signal according to an embodiment of the present disclosure.

FIG. 23 is another specific schematic diagram of sending a synchronization signal according to an embodiment of the present disclosure.

FIG. 24 is another specific schematic diagram of sending a synchronization signal according to an embodiment of the present disclosure.

FIG. 25 is another specific schematic diagram of sending a synchronization signal according to an embodiment of the present disclosure.

FIG. 26 is another specific schematic diagram of sending a synchronization signal according to an embodiment of the present disclosure.

FIG. 27 is a schematic flowchart of another method for wireless communication according to an embodiment of the present disclosure.

FIG. 28 is a schematic block diagram of a terminal device according to an embodiment of the present disclosure.

FIG. 29 is a schematic block diagram of a network device according to an embodiment of the present disclosure.

FIG. 30 is a schematic block diagram of a communication device according to an embodiment of the present disclosure.

FIG. 31 is a schematic block diagram of apparatus according to an embodiment of the present disclosure.

FIG. 32 is a schematic block diagram of a communication system according to an embodiment of the present disclosure.

### DETAILED DESCRIPTION

The technical schemes of the embodiments of the present disclosure would be clearly and completely described in conjunction with the accompanying drawings in the embodiments of the present disclosure. It is apparent that the described embodiments are only part of the embodiments of the present disclosure, not all the embodiments. All other embodiments obtained by those of ordinary skill in the art with respect to the embodiments of the present disclosure without creative efforts all fall within the scope of protection of the present disclosure.

The technical scheme in the embodiments of the present disclosure may be applied to various communication systems, such as: a Global System Of Mobile Communication (GSM) system, a Code Division Multiple Access (CDMA) system, a Wideband Code Division Multiple Access (WCDMA) system, a General Packet Radio Service (GPRS), a Long Term Evolution (LTE) system, an Advanced Long Term Evolution (LTE-A) system, a New Radio (NR) system, an evolution system for NR system, a LTE-based access to Unlicensed Spectrum (LTE-U) system, a NR-based access to Unlicensed Spectrum (NR-U) system, a Non-Terrestrial Networks (NTN) system, a Universal Mobile Telecommunication System (UMTS), a Wireless Local Area Network (WLAN), a Wireless Fidelity (Wi-Fi), a 5th-generation (5G) system or other communication systems.

Generally speaking, traditional communication systems support a limited number of connections and are easy to implement. However, with the development of communication technology, mobile communication systems will not only support traditional communication, but also support, for example, Device to Device (D2D) communication, Machine To Machine (M2M) communication, Machine Type Communication (MTC), Vehicle To Vehicle (V2V) communication, or V2X communication, etc. The embodiments of the present disclosure may also be applied to these communication systems.

Optionally, the communication system in the embodiments of the present disclosure may be applied to a Carrier Aggregation (CA) scenario, a Dual Connectivity (DC) scenario, and a Standalone (SA) network distribution scenario.

Optionally, the communication system in the embodiments of the present disclosure may be applied to an unlicensed spectrum, and the unlicensed spectrum may also be considered as a shared spectrum. Optionally, the communication system in the embodiments of the present disclosure may also be applied to a licensed spectrum, and the licensed spectrum may also be considered as a non-shared spectrum.

The embodiments of the present disclosure are described in connection with a network device and a terminal device. The terminal device may also be referred to as User Equipment (UE), an access terminal, a user unit, a user station, a mobile station, a remote station, a remote terminal, a mobile device, a user terminal, a terminal, a wireless communication device, a user agent or a user device, etc.

The terminal device may be a Station (ST) in the WLAN, a cellular telephone, a cordless telephone, a Session Initiation Protocol (SIP) telephone, a Wireless Local Loop (WLL) station, a Personal Digital Assistant (PDA) device, a handheld device having a wireless communication function, a computing device or other processing device connected to a wireless modem, a vehicle-mounted device, a wearable device, a terminal device in a next generation communication system such as an NR network, or a terminal device in a future evolved Public Land Mobile Network (PLMN) network, etc.

In the embodiments of the present disclosure, the terminal device may be deployed on land, and include indoor or outdoor device, hand-held device, wearable device or vehicle-mounted device. The terminal device may also be deployed on the water (such as on the ships, etc.). The terminal device may also be deployed in the air (such as, in airplanes, in balloons and in satellites, etc.).

In the embodiments of the present disclosure, the terminal device may be a mobile phone, a Pad, a computer with wireless transceiver function, a Virtual Reality (VR) terminal device, an Augmented Reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, or a wireless terminal device in smart home, etc.

By way of example and not limitation, in the embodiments of the present disclosure, the terminal device may also be a wearable device. The wearable device may also be referred to as a wearable smart device, which is a general term of wearable devices that are intelligently designed and developed by applying wearable technology to daily wear, such as, glasses, gloves, watches, clothing and shoes. The wearable device is a portable device that is worn directly on the body or integrated into the user's clothes or accessories. The wearable device is not only a kind of hardware device, but also realizes powerful functions through software support, data interaction and cloud interaction. The generalized wearable smart device has full functions and a large size, and the generalized wearable smart device may realize complete or partial functions without relying on smart phones, such as smart watches or smart glasses, and the generalized wearable smart device only focus on certain application functions and need to be used in conjunction with other devices (such as, smart phones), such as, various smart bracelets and smart jewelry for monitoring physical signs.

In the embodiments of the present disclosure, the network device may be a device configured to communicate with a mobile device, and the network device may be an access point (AP) in a WLAN, a Base Transceiver Station (BTS) in a GSM or CDMA, a NodeB (NB) in a WCDMA, an evolved Node B (eNB or eNodeB) in an LTE, a relay station or an access point, a vehicle-mounted device, a wearable device, a network device or a gNB in an NR network, a network device in a future evolved PLMN network or a network device in an NTN network, etc.

By way of example and not limitation, in the embodiments of the present disclosure, the network device may have mobility characteristics, for example, the network device may be a mobile device. Optionally, the network device may be a satellite, a balloon station. For example, the satellite may be a Low Earth Orbit (LEO) satellite, a Medium Earth Orbit (MEO) satellite, a Geostationary Earth Orbit (GEO) satellite, a High Elliptical Orbit (HEO) satellite, and the like. Optionally, the network device may also be a base station located on land, water, etc.

In the embodiments of the present disclosure, the network device may provide a service for a cell, and the terminal device communicates with the network device through transmission resources (e.g., frequency resources, or spectrum resources) used by the cell. The cell may be a cell corresponding to the network device (e.g., base station), and the cell may belong to a macro base station or a base station corresponding to a small cell. The small cell may include a metro cell, a micro cell, a Pico cell, a Femto cell, etc. These small cells have characteristics of small coverage and low transmission power, and the small cells are suitable for providing a high-speed data transmission service.

It is to be understood that the terms “system” and “network” are often used interchangeably herein. In the present disclosure, the term “and/or” is only an association relationship describing associated objects and represents that three relationships may exist. For example, A and/or B may represent three conditions: i.e., independent existence of A, existence of both A and B and independent existence of B. In addition, the character “/” in the present disclosure generally indicates that the relationship between the related objects is “or”.

Terms used in the embodiments of the present disclosure are used only for explanation of specific embodiments of the present disclosure and the terms are not intended to limit the present disclosure. The terms “first”, “second” and the like in the description and claims of the present disclosure and the accompanying drawings are used to distinguish different objects and are not used to describe a particular sequence. Furthermore, the terms “including” and “having” and any variations thereof are intended to cover non-exclusive inclusion.

It is to be understood that the reference to “indication” in the embodiments of the present disclosure may be a direct indication, may be an indirect indication, or may be indicative of an association. For example, A indicates B, which may mean that A directly indicates B, for example, B may be obtained through A; it may also mean that A indirectly indicates B, for example, A indicates C, and B may be obtained by C; and it may also indicate that there is an association between A and B.

In the description of the embodiments of the present disclosure, the term “correspondence” may mean that there is a direct correspondence or an indirect correspondence between the two, may also mean that there is an association relationship between the two, and may also be a relationship between indication and being indicated, configuration and being configured, etc.

In the embodiments of the present disclosure, the term “predefined” may be achieved by pre-storing corresponding codes, tables or other means used for indicating relevant information in devices (e.g., including terminal devices and network devices), and the specific implementation thereof is not limited in the present disclosure. For example, predefined may refer to what is defined in the protocol.

In the embodiments of the present disclosure, the “protocol” may be a standard protocol in the communication field. For example, the protocol may include an LTE protocol, an NR protocol, and related protocols applied in future communication systems, which are not limited in the present disclosure.

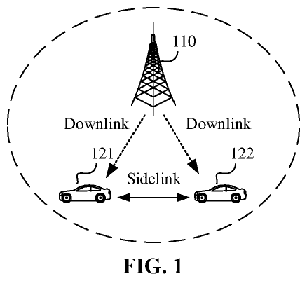

FIG. 1 is a schematic diagram of a communication system to which embodiments of the present disclosure are applied. Transmission resources of vehicle-mounted terminals (a vehicle-mounted terminal 121 and a vehicle-mounted terminal 122) are allocated by a base station 110 and the vehicle-mounted terminals send data on the sidelink according to the resources allocated by the base station 110. Specifically, the base station may allocate, to the terminal, resources for single transmission or semi-static transmission.

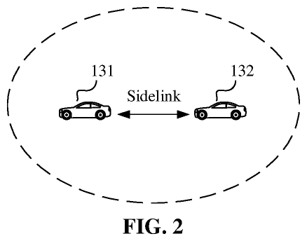

FIG. 2 is another schematic diagram of a communication system to which embodiments of the present disclosure are applied. Vehicle-mounted terminals (a vehicle-mounted terminal 131 and a vehicle-mounted terminal 132) autonomously select transmission resources among resources of the sidelink to perform data transmission. Optionally, the vehicle-mounted terminal may randomly select a transmission resource or select the transmission resource in a sensing manner.

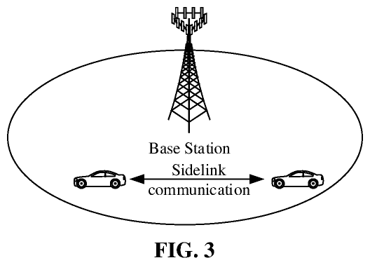

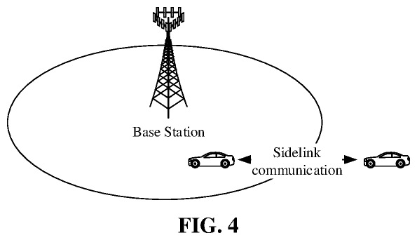

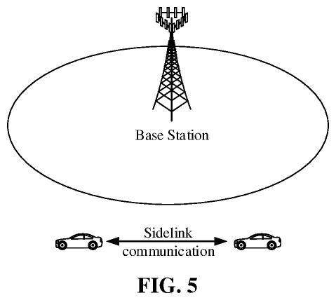

It is to be noted that in the sidelink communication, according to the network coverage situation where a terminal performing the communication is located, the sidelink communication may be divided into sidelink communication within network coverage as shown in FIG. 3; sidelink communication partly within network coverage as shown in FIG. 4; and sidelink communication outside network coverage as shown in FIG. 5.

In FIG. 3, in the sidelink communication within network coverage, all the terminals performing the sidelink communication are located within the coverage of the same base station, so that all the terminals are able to perform the sidelink communication, based on the same sidelink configuration, by receiving the configuration signaling from the base station.

In FIG. 4, in the situation of the sidelink communication partly within network coverage, a part of terminals performing sidelink communication are located within the coverage of the base station, and these terminals are able to receive the configuration signaling from the base station and perform the sidelink communication according to the configuration from the base station. Terminals located outside the network coverage are unable to receive the configuration signaling from the base station. In this case, the terminals outside the network coverage determine sidelink configuration according to pre-configuration information and information carried in a Physical Sidelink Broadcast Channel (PSBCH) sent by the terminal located within the network coverage, so as to perform the sidelink communication.

In FIG. 5, for the sidelink communication outside network coverage, all terminals performing the sidelink communication are located outside the network coverage, and all terminals determine the sidelink configuration according to pre-configuration information to perform the sidelink communication.

It is to be noted that a device-to-device communication is a sidelink transmission technology based on Device to Device (D2D), which is different from the traditional cellular system in which communication data is received or sent by a base station. Therefore, the device-to-device communication has higher spectrum efficiency and lower transmission delay. In the Vehicle-To-Everything (V2X) system, terminal-to-terminal direct communication is adopted. The 3GPP defines two transmission modes: first mode and second mode.

In the first mode, transmission resources of a terminal are allocated by a base station, and the terminal sends data on the sidelink according to the resources allocated by the base station. The base station may allocate, to the terminal, resources for single transmission or semi-static transmission. As shown in FIG. 3, the terminals are located within the network coverage, and the network allocates the transmission resources for sidelink transmission to the terminals.

In the second mode, the terminal selects, in the resource pool, a resource for data transmission. As shown in FIG. 5, the terminals are located outside the coverage of the cell, and the terminals autonomously select transmission resources in a pre-configured resource pool to perform the sidelink transmission. Optionally, as shown in FIG. 3, the terminals autonomously select transmission resources from a resource pool configured by the network to perform the sidelink transmission.

In NR-V2X, autonomous driving is supported, so higher requirements are put forward for data interaction between vehicles, such as higher throughput, lower delay, higher reliability, larger coverage and more flexible resource allocation.

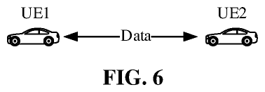

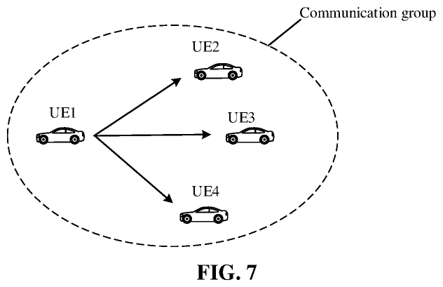

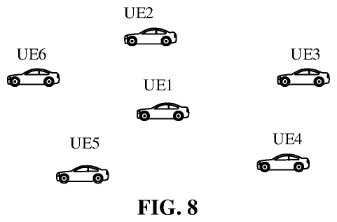

In LTE-V2X, the broadcast transmission mode is supported, and in NR-V2X, the unicast transmission mode and the multicast transmission mode are introduced. For the unicast transmission, there is only one terminal at the receiving end, and as shown in FIG. 6, the unicast transmission is performed between UE1 and UE2. For the multicast transmission, the receiving end includes all terminals in a communication group or all terminals within a certain transmission distance. As shown in FIG. 7, UE1, UE2, UE3 and UE4 form a communication group, in which UE1 sends data, and other terminals in the group are terminals at the receiving end. For the broadcast transmission mode, the terminal at the receiving end is any one terminal around a terminal at the sending end. As shown in FIG. 8, UE1 is the terminal at the sending end, and other terminals around UE1, i.e., UE2 to UE6, are all terminals at the receiving end.

Resource pool is introduced into the sidelink transmission system. The so-called resource pool is the set of transmission resources, and both the transmission resources configured by the network and the transmission resources selected by the terminal independently are resources in the resource pool. The resource pool may be pre-configured or may be configured by the network, and one or more resource pools may be configured. The resource pool is divided into sending resource pool and receiving resource pool. The transmission resources in the sending resource pool are used for sending sidelink data; and the terminal receives sidelink data on the transmission resources in the receiving resource pool.

In order to better understand the embodiments of the present disclosure, a sensing-based resource selection method related to the present disclosure is described.

In the LTE-V2X, a full sensing or a partial sensing is supported. The full sensing means that the terminal may sense all slots (or subframes) where other terminals send data except for a slot where its data transmissions occur. The partial sensing is intended for saving energy of the terminal, the terminal only needs to sense a part of slots (or subframes), and performs resource selection based on a result of the partial sensing.

Specifically, when the partial sensing is not configured by high layers, it is defaulted that the manner of the full sensing is adopted to perform the resource selection.

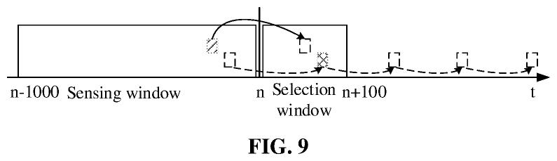

When a new data packet arrives at a moment n, and the resource selection is required, then the terminal will perform the resource selection within [n+T1, n+T2] ms according to a sensing result in the past 1 second, where T1≤4; and T₂ₘᵢₙ (prio_{TX})≤T₂≤100, T₂ₘᵢₙ (prio_{TX}) is a parameter configured by high layers. T₁ should be selected to be greater than a processing delay of the terminal, and the T₂ should be selected to be within a service delay requirement range. For example, if the service delay requirement is 50 ms, then 20≤T₂≤50; and if the service delay requirement is 100 ms, then 20≤T₂≤100, as shown in FIG. 9.

The procedure of the terminal performing the resource selection within a selection window is as follows (the specific procedure of the resource selection may refer to the operation steps described in the above standard, and several main steps of the resource selection are listed herein).

1. The terminal takes all available resources within the selection window as a set A.

2. If the terminal has no sensing result for some subframes within a sensing window, then resources on subframes in the selection window corresponding to these subframes are excluded.

3. If the terminal detects a Physical Sidelink Control Channel (PSCCH) within the sensing window, then a Reference Signal Received Power (RSRP) of a Physical Sidelink Shared Channel (PSSCH) scheduled by the PSCCH is measured. If the measured PSSCH-RSRP is higher than a PSSCH-RSRP threshold, and a reserved transmission resource determined according to reservation information in the control information has resource conflict with the data to be sent by a user, then the user excludes the resource from the set A. The selection of the PSSCH-RSRP threshold is determined by priority class information carried in the detected PSCCH and a priority class of the data to be transmitted by the terminal.

4. If the number of remaining resources in the set A is less than 20% of the total number of resources in the set A, the terminal will raise the PSSCH-RSRP threshold by 3 dB, and repeat the steps 1-3 until the number of the remaining resources in the set A is greater than 20% of the total number of the resources in the set A.

5. The terminal performs Sidelink Received Signal Strength Indicator (S-RSSI) detection on the remaining resources in the set A, sorts the resources according to the energy level, and moves the 20% resources with lower energy of the total number of the resources from the set A to a set B.

6. The terminal selects a resource from the set B with an equal probability to perform data transmission.

Compared with the full sensing manner, the terminal, using the partial sensing, selects Y slots within the resource selection window, and determines whether resources on Y slots may be used as candidate resources according to the sensing result. If so, the resources on Y slots may be put into a set SB. If the number of elements in the set SB is greater than or equal to 20% of the total number of the resources on Y slots, the SB is reported to high layers.

In order to better understand the embodiments of the present disclosure, a Listen Before Talk (LBT) technology related to the present disclosure is described.

An unlicensed spectrum is a spectrum divided by countries and regions and may be used for radio device communication. This spectrum is usually considered as a shared spectrum. That is to say, communication devices in different communication systems may use this spectrum as long as the communication devices satisfy regulatory requirements set by the countries or the regions on this spectrum, without applying for dedicated spectrum license from the government.

In order to make all communication systems using the unlicensed spectrum coexist amicably on this spectrum, some countries or regions have established the regulatory requirements that must be satisfied when the unlicensed spectrum is used. For example, communication devices follow the “LBT” principle, i.e., a communication device needs to perform channel sensing before sending a signal on a channel of the unlicensed spectrum, and only when a channel sensing result is that the channel is idle, can the communication device send the signal; and if the channel sensing result of the sensing performed by the communication device on the channel of the unlicensed spectrum is that the channel is busy, the communication device cannot send the signal. In order to ensure the fairness, in one transmission, a duration where the communication device performs signal transmission using the channel of the unlicensed spectrum cannot exceed a Maximum Channel Occupancy Time (MCOT).

Basic concepts of the transmission on the shared spectrum include follows.

MCOT: which is an allowed maximum duration where the signal transmission is performed by using a channel of a shared spectrum after channel sensing on the channel is successful.

Channel Occupancy Time (COT): which is a duration where signal transmission is performed by using a channel of a shared spectrum after channel sensing on the channel is successful, and may also be considered as a duration where a channel of a shared spectrum is occupied after the successful channel sensing on the channel. The signal occupying the channel may be continuous or discontinuous within the duration, and the duration includes the total time the device initiating channel occupancy takes for signal transmission and the device sharing the channel occupancy takes for signal transmission.

gNB/eNB-initiated COT: which is also known as COT initiated by a network device, and the gNB/eNB-initiated COT refers to one channel occupancy time obtained by the network device after the channel sensing on the channel of the shared spectrum is successful. The COT initiated by the network device may not only be used for the transmission performed by the network device, but also be used for the transmission performed by the terminal device under certain conditions. The gNB/eNB-initiated COT being used for the transmission performed by the terminal device is also called that the terminal device shares the COT to perform the transmission.

UE-initiated COT: which is also known as the COT initiated by the terminal device, and the UE-initiated COT refers to time for occupying a channel of a shared channel once obtained by the terminal device after the channel sensing on the channel is successful. The COT initiated by the terminal device may not only be used for the transmission performed by the terminal device, but also be used for the transmission performed by the network device under certain conditions.

Downlink transmission burst: which is a group of downlink transmissions (i.e., including one or more downlink transmissions) performed by the network device. The group of downlink transmissions is continuous transmission (i.e., there is no gap between multiple downlink transmissions), or has a gap, but the gap is less than or equal to 16 μs. If the gap between two downlink transmissions performed by the network device is greater than 16 μs, then the two downlink transmissions are considered to be two downlink transmission bursts.

Uplink transmission burst: which is a group of uplink transmissions (i.e., including one or more uplink transmissions) performed by the terminal device. The group of uplink transmissions is continuous (i.e., there is no gap between multiple uplink transmissions), or has a gap, but the gap is less than or equal to 16 μs. If the gap between two uplink transmissions performed by the terminal device is greater than 16 μs, then the two uplink transmissions are considered to be two uplink transmission bursts.

Channel sensing success: also known as channel sensing idle. For example, the energy sensing in a slot where channel sensing is performed is lower than an energy sensing threshold.

Channel sensing failure: which is also known as channel sensing busy. For example, the energy sensing in a slot where channel sensing is performed is higher than or equal to an energy sensing threshold.

Channel Access Type (CAT or Cat): which includes Type 1 channel access or Type 2 channel access. Type 1 channel access is equivalent to Cat-4 LBT, and Type 2 channel access is equivalent to Cat-2 LBT with 25 μs.

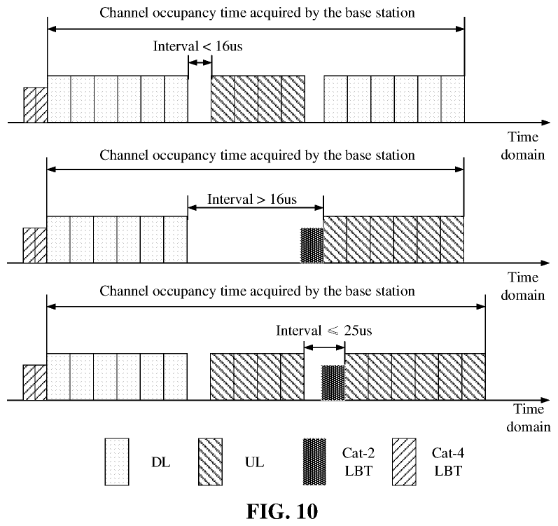

In some embodiments, when the network device initiates a COT, resources within the COT may be used for the UE to perform uplink transmission. For an uplink transmission burst occurring within the GNB/eNB-initiated COT, if a gap between a starting position of the uplink transmission burst and an ending position of a downlink transmission burst is less than 16 μs, then the UE may immediately perform the uplink transmission (or Cat-1 LBT). If there is no downlink (DL) transmission burst behind the uplink (UL) transmission burst within the GNB/eNB-initiated COT, then the UE may perform a Cat-2 LBT before transmission. If a gap between any two adjacent transmissions within the GNB/eNB-initiated COT is less than or equal to 25 μs, then the UE may perform the Cat-2 LBT. FIG. 10 shows such an example.

The Cat-1 LBT may mean that the communication device performs the transmission without performing the channel sensing after the gap ends. The Cat-2 LBT may mean that the communication device performs a single-slot channel sensing, and in particular, the Cat-2 LBT may include a single-slot channel sensing with 25 us and a single-slot channel sensing with 16 μs. For an uplink transmission burst occurring within the GNB/eNB-initiated COT, if a gap between the starting position of the uplink transmission burst and the ending position of a downlink transmission burst is 16 μs, then the UE may perform the Cat-2 LBT with 16 us before the uplink transmission. If the gap between the starting position of the uplink transmission burst and the ending position of the downlink transmission burst is 25 μs, then the UE may perform the Cat-2 LBT with 25 us before the uplink transmission. The network device may ensure the size of the gap between the starting position of the uplink transmission burst and the ending position of the downlink transmission burst, and notify information of the size of the gap or corresponding LBT mode to the terminal device.

It is to be understood that the manner for the network device to obtain the channel occupancy time may be a channel access manner of Load based Equipment (LBE). That is to say, the communication device may perform the LBT on the unlicensed spectrum after the service arrives, and start the transmission of the signal after the LBT is successful. The manner for the network device to obtain the channel occupancy time may also be a channel access manner of Frame based equipment (FBE). That is to say, the communication device periodically performs the LBT on the unlicensed spectrum.

If the channel access manner of LBE is used, the network device may obtain the channel occupancy time through the Cat-4 LBT. The Cat-4 LBT may refer to that the channel sensing manner of the communication device is a contention window adjustment-based random backoff multi-slot channel sensing. Specifically, the Cat-4 LBT may include different channel access priorities according to the priorities of transmission services.

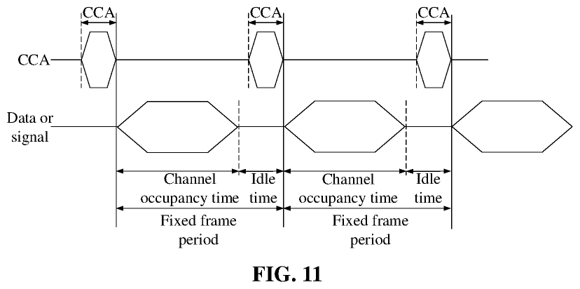

If the channel access manner of FBE is used, as shown in FIG. 11, frame structures appear periodically in this manner, and one frame structure includes a fixed frame period (with a length not exceeding 200 ms), channel occupancy time (with a length not exceeding 95% of the fixed frame period), idle time (with a length being at least 5% of the channel occupancy time, the minimum value of 100 μs, and located at the tail of the fixed frame period). In addition, a Clear Channel Assessment (CCA) is also performed. The network device performs LBT (which for example may be single-slot channel sensing) on the unlicensed spectrum in a gap, if the LBT is successful, the channel occupancy time in the next fixed frame period may be used for transmitting the signal; and if the LBT fails, the channel occupancy time in the next fixed frame period cannot be used for transmitting the signal. In other words, the channel resources of the communication device that may be used for the service transmission appear periodically.

To facilitate a better understanding of the embodiments of the present disclosure, an indication of the channel access type in a Long Term Evolution Licensed-Assisted Access (LTE-LAA) system is described.

In the LTE-LAA system, when the terminal device is scheduled to transmit a Physical Uplink Shared Channel (PUSCH), the network device will indicate a channel access type and a channel access priority class corresponding to the PUSCH by Downlink Control Information (DCI) carrying a UL grant.

The Channel Access Type (CAT) occupies 1 bit and indicates Type 1 channel access type or Type 2 channel access, where Type 1 channel access is equivalent to Cat-4 LBT, and Type 2 channel access is equivalent to Cat-2 LBT with 25 μs. The principle of network device indicating the channel access type is that: if a PUSCH to be transmitted belongs to gNB/eNB-initiated COT, then the network device indicates the Cat-2 LBT; otherwise, the network device indicates the Cat-4 LBT.

The Channel Access Priority Class (CAPC) occupies 2 bits, and when the channel access type is Type 1, the 2 bits are used for determining the corresponding channel access parameters from Table 1 below. Table 1 shows channel access parameters corresponding to different channel access priority classes under the Cat-4 LBT. The smaller a value of p, the higher the channel access priority class.

TABLE 1

| | | | | | Allowed values of |
|---|---|---|---|---|---|
| CAPC (p) | mₚ | CW_{min, p} | CW_{max, p} | T_{mcot, p} | CWₚ |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 | {15, 31, 63, 127, |
| | | | | ms | 255, 511, 1023} |
| 4 | 7 | 15 | 1023 | 6 ms or 10 | {15, 31, 63, 127, |
| | | | | ms | 255, 511, 1023} |

It is to be noted that in Table 1 above, mₚ is the number of backoff slots corresponding to the channel access priority class p, CWₚ is the contention window size corresponding to the channel access priority class p, CW_{min,p} is the minimum value of CWₚ corresponding to the channel access priority class p, CW_{max,p} is the maximum value of CWₚ corresponding to the channel access priority class p, and T_{mcot,p} is the length of the MCOT corresponding to the channel access priority class p.

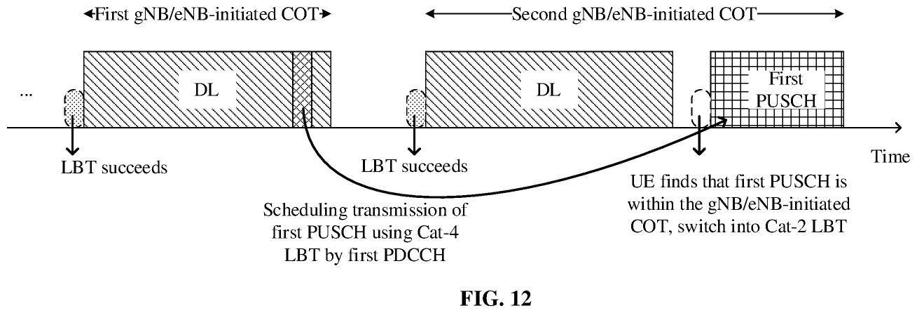

It is also to be noted that only one uplink and downlink switching point is allowed during the gNB/eNB-initiated COT. In addition, in a case where the channel access type corresponding to a PUSCH to be transmitted by the terminal device is indicated as the Type 1 of the channel access type, and if the terminal device receives common indication information sent by the network device, determines resources of an uplink transmission shared to uplink transmission in the gNB/eNB-initiated COT according to the common indication information, and determines that the PUSCH to be transmitted (i.e., a first PUSCH scheduled by a first Physical Downlink Control Channel (PDCCH)) belongs to the gNB/eNB-initiated COT, then the terminal device may switch the Type 1 of the channel access type corresponding to the PUSCH into the Type 2 of the channel access type, as shown in FIG. 12.

In order to facilitate a better understanding of the embodiments of the present disclosure, indication of the channel access type in a NR-U system is described.

Similar to the LTE-LAA system, in the NR-U system, when terminal device is scheduled to perform transmission of a PUSCH, the network device may also indicate the channel access type and the channel access priority class corresponding to the PUSCH through Downlink Control Information (DCI) carrying the UL grant.

Unlike the LTE-LAA, in the NR-U system, the channel access types to be indicated may include Cat-1 LBT, Cat-2 LBT, and Cat-4 LBT. The Cat-2 LBT includes the Cat-2 LBT with 25 us and the Cat-2 LBT with 16 μs. In addition, there may be more than one uplink and downlink handover point during the gNB/eNB-initiated COT in the NR-U system.

In order to facilitate a better understanding of the embodiments of the present disclosure, a synchronization mechanism of the sidelink related to the present disclosure is described.

Due to the limitation of half-duplex, a terminal is unable to receive a signal on one carrier while sending a signal on the same carrier simultaneously. In order to avoid loss of sidelink data caused by the terminal being unable to receive the sidelink data sent by other terminals when sending the sidelink synchronization signal, in the sidelink transmission, the synchronization transmission resource and the sidelink data transmission resource are Time Division Multiplexing (TDM), i.e., the Frequency Division Multiplexing (FDM) between the sidelink synchronization signal and the sidelink data is not supported. Furthermore, when a resource pool for the sidelink data transmission is determined, a subframe or a slot where the synchronization signal is located is excluded from the available time-domain resources, i.e., the synchronization resource is not included in the resource pool.

In addition, due to the limitation of the half-duplex, the terminal needs to send and receive a sidelink synchronization signal on different time-domain resources. Therefore, in the LTE-V2X, two or three subframes are required to be used as synchronization resources within each synchronization period, and the third synchronization resource is introduced to mainly be used for taking the Global Navigation Satellite System (GNSS) as the terminal of a synchronization source to send the synchronization signal.

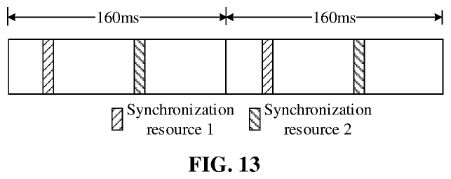

As shown in FIG. 13, the period of the synchronization resource in the LTE-V2X system is 160 ms, and each synchronization period includes two synchronization subframes. When the terminal acquires synchronization information on a synchronization resource 1, the synchronization signal is sent on a synchronization resource 2. Similarly, when the terminal acquires the synchronization information on the synchronization resource 2, the synchronization signal may be sent on the synchronization resource 1.

Since there are only two or three subframes used for transmitting the synchronization signal within one synchronization period, and there are many terminals sending synchronization signals, multiple terminals send the synchronization signals on each synchronization resource. The priority classes of the synchronization signals sent by different terminals may be different. When a terminal detects the synchronization signal on the synchronization resource, synchronization signals with different priority classes may be detected, and the terminal selects a synchronization source from multiple candidate synchronization sources according to an order of the priority classes.

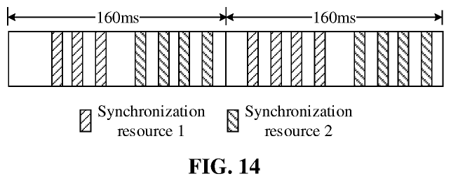

As shown in FIG. 14, a design of the synchronization resource in the NR Uu system and a design of the synchronization resource in the LTE-V2X system are combined to obtain a design of the synchronization resource in the NR-V2X system. In the NR Uu system, the period of the synchronization resource is also 160 ms, and multiple Synchronization Signal Block (SSB) transmission opportunities are included in one period, which is mainly because in the Frequency range 2 (FR2), different beams are required to be used to transmit SSB respectively, so as to achieve full coverage for the cell. In the LTE-V2X system, two or three synchronization subframes are required in each synchronization period to overcome the influence of the half-duplex. Therefore, in the NR-V2X system, two or three sets of synchronization resources are supported in each synchronization period, and each set of synchronization resources includes multiple transmission opportunities. The multiple transmission opportunities can improve the detection performance of the terminal. The beam-based sidelink transmission is not supported in the R16 of the NR-V2X.

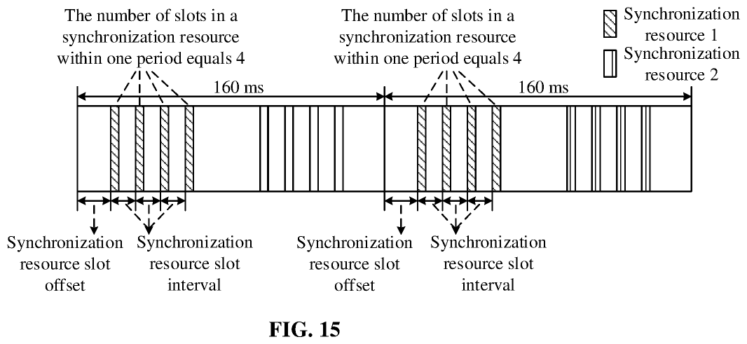

The existing V2X synchronization resource scheme is shown in FIG. 15. In the NR-V2X system, two sets of synchronization resources are configured within each synchronization period with 160 ms, and four synchronization slots are configured within each set of synchronization resources. The sender may send the synchronization signal on four slots respectively. When the terminal detects the synchronization signal on a certain synchronization slot, the terminal may determine whether the synchronization slot belongs to the first set of synchronization resources or the second set of synchronization resources according to the Direct Frame Number (DFN) and a slot number carried in PSBCH transmitted simultaneously with the synchronization signal, and then the terminal sends the synchronization signal on four slots of another set of synchronization resources respectively.

The period of the synchronizing resource in the NR-V2X system is also 160 ms. Since the NR-V2X supports different Sub-carrier Spacings (SCSs), the number of slots included in one synchronization period is 160*2μ, where μ=0, 1, 2 and 3 corresponding to sub-carrier spacings of 15 kHz, 30 kHz, 60 kHz and 120 kHz, respectively, and corresponding slot intervals of 1 ms, 0.5 ms, 0.25 ms and 0.125 ms, respectively. In the NR-V2X system, up to 3 sets of synchronization resources may be configured within one synchronization period. For each set of synchronization resources, a slot where each synchronization resource is located within one period is determined by the following three parameters:

1) The number of synchronization slots within one period (sl-NumSSB-WithinPeriod: which is the number of synchronization slots included in each set of synchronization resources within one synchronization period. Specifically, the number of synchronization slots supported in each set of synchronization resources with different sub-carrier spacings in FR1 is as follows:
15 kHz SCS: {1},
30 KHz SCS: {1, 2},
30 kHz SCS: {1, 2, 4}.

The number of synchronization slots supported in each set of synchronization resources with different sub-carrier spacings in FR2 is as follows:
60 KHz SCS: {1, 2, 4, 8, 16, 32},
120 KHz SCS: {1, 2, 4, 8, 16, 32, 64}.

2) Synchronization slot offset (sl-TimeOffsetSSB): which is a slot offset of a first synchronization resource in each set of synchronization resources within one synchronization period relative to the synchronization period boundary.

3) Slot interval (sl-TimeInterval): which is a slot interval between two adjacent synchronization resources in each set of synchronization resources within one synchronization period.

In order to facilitate a better understanding of the embodiments of the present disclosure, related art and the existing problems of the present disclosure are explained.

In the sidelink transmission of the NR-V2X system, there may be multiple terminals sending the synchronization signals, and multiple terminals may send the synchronization signals on each synchronization resource in the sidelink transmission. In this case, as a manner for the multiple terminals to send the synchronization signal on the synchronization resource, the terminal device may support determining whether to use synchronization resource for sending the synchronization signal in a manner of performing the channel access through the sensing (e.g. LBT). When a terminal determines, through channel access, that a synchronization resource is unavailable, the terminal device does not use the synchronization resource to send the synchronization signal. For example, when two sets of synchronization resources are configured within one synchronization period, and each set of synchronization resources includes four synchronization slots, the terminal device may detect each synchronization slot through the LBT, and if one synchronization slot is found to be unavailable, the terminal does not use the synchronization slot to send the synchronization signal. Then, the synchronization resources configured according to the existing mechanism may not be enough. For example, four synchronization slots should be occupied for sending the synchronization signal, but only one or two of the synchronization slots may be used for sending the synchronization signal after the LBT, which leads to degradation of the synchronization performance of the sidelink, and thus affect the data transmission of the sidelink and reduce the system performance.

Based on the above problems, the present disclosure provides a sidelink transmission scheme. In the scheme, the synchronization resource in the sidelink transmission is configured to include N synchronization slots, and the terminal device sends, according to a result of performing channel access on the synchronization resource, a synchronization signal by occupying at least part of synchronization slots among the N synchronization slots in the synchronization resource. That is to say, in the sidelink transmission scheme provided by the present disclosure, since the synchronization resource configured for the terminal device includes an additional number of synchronization slot resources, i.e. redundant synchronization slot resources, the terminal device may send the synchronization signal by occupying a part of or all of the synchronization slots, which helps the terminal device to determine whether to use the synchronization resource for sending the synchronization signal in a manner of sensing (e.g. the LBT), and helps to support multiple terminal devices to send synchronization signals on one synchronization resource, thereby improving reliability and completeness of a synchronization mechanism of the sidelink, improving the data transmission performance of the sidelink and improving the system performance.

The technical scheme of the present disclosure will be described in detail by a specific embodiment below.

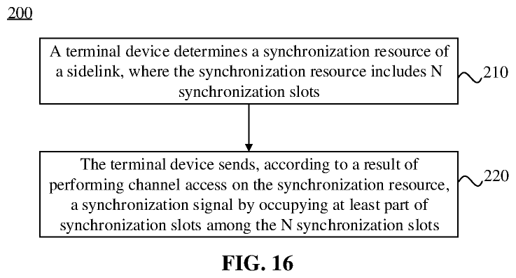

FIG. 16 is a schematic flowchart of a method 200 for wireless communication according to an embodiment of the present disclosure. As shown in FIG. 16, the method 200 may include at least some of the following contents.

In operation 210, a terminal device determines a synchronization resource of a sidelink, where the synchronization resource includes N synchronization slots, and N is a positive integer.

In operation 220, the terminal device sends, according to a result of performing channel access on the synchronization resource, a synchronization signal by occupying at least part of synchronization slots among the N synchronization slots.

Therefore, according to the embodiment of the present disclosure, the synchronization resource of the terminal device includes the additional number of synchronization slot resources, i.e. redundant synchronization slot resources, so that the terminal device may send the synchronization signal by occupying a part of or all of synchronization slots among the N synchronization slots, which helps the terminal device to determine whether to use the synchronization resource for sending the synchronization signal according to the result for the channel access, and helps to support multiple terminal devices to send synchronization signals on one synchronization resource, thereby improving the reliability and the completeness of the synchronization mechanism of the sidelink, and improving the system performance.

In some embodiments, the channel access is also referred to as a channel access procedure. For example, the channel access procedure may be a procedure of initiating the channel access through channel sensing, or channel monitoring, or channel detection. As an example, the channel access may be an LBT procedure.

In some embodiments, the operation that the terminal device sends, according to a result of performing channel access on the synchronization resource, a synchronization signal by occupying at least part of synchronization slots among the N synchronization slots may also be expressed as that: the terminal device occupies, according to the result of performing the LBT on the synchronization resource, the at least part of synchronization slots among the N synchronization slots to send the synchronization signal. For example, if the terminal device succeeds in the LBT on synchronization resource, such as a part or all of the synchronization slots, then at least part of synchronization slots among the N synchronization slots are occupied to send the synchronization signal. If the terminal device fails in the LBT on synchronization resource, such as one of the synchronization slots, then the terminal device determines not to send the synchronization signal by using the synchronization slot.

In some embodiments, the channel access procedure includes one of the following:

a first type of channel access procedure, a second type of channel access procedure, or a third type of channel access procedure.

The first type of channel access procedure includes Type1 channel access, the second type of channel access procedure includes Type 2A channel access and/or Type 2B channel access, and the third type of channel access procedure includes Type 2C channel access.

Alternatively, the first type of channel access procedure includes Type2A channel access, the second type of channel access procedure includes Type2B channel access, and the third type of channel access procedure includes Type2C channel access.

In some embodiments, in a case where the synchronization resource is located within a shared COT, the channel access procedure is the second type of channel access procedure or the third type of channel access procedure.

In some embodiments, in a case where the synchronization resource is not located within the shared COT, the channel access procedure is the first type of channel access procedure.

It should be noted that in the shared spectrum, such as the synchronization resource, a communication device needs to perform LBT (also called channel sensing) before sending a channel or a signal, and the transmission may be performed only after the LBT is successful, and the transmission cannot be performed if the LBT is failed. Therefore, the communication on shared spectrum is opportunistic transmission. From the perspective of system network layout, the channel sensing includes two mechanisms, one is LBE LBT that is also called dynamic channel sensing, dynamic channel access or dynamic channel occupancy; and the other is FBE LBT that is also called semi-static channel sensing, semi-static channel access or semi-static channel occupancy.

In the channel access mechanism of the LBE, or in the dynamic channel access mode, multiple different channel access schemes are included, such as Type 1 channel access, Type 2A channel access, Type 2B channel access and Type 2C channel access.

### Type 1 Channel Access:

The manner of the channel sensing performed by the communication device is a contention window adjustment-based random backoff multi-slot channel sensing. The number of detection slots on which the channel sensing is required to be performed is randomly generated according to the contention window, and the size of the contention window is determined according to a CAPC corresponding to a transmission service. Specifically, for the Type 1 channel access, different CAPCs may be included according to the priority classes of the transmission services. For example, the above Table 1 is an example of channel access parameters corresponding to different channel access priority classes. The smaller the value of p, the higher the channel access priority class. Optionally, the above Table 1 is used for the Type 1 channel access for the uplink transmission of the terminal device.

### Type 2A Channel Access:

The manner of the channel sensing performed by a communication device is single-sensing slot channel sensing with a fixed length of 25 μs. Specifically, for the Type 2A channel access, the communication device may perform the channel sensing within a sensing slot with 25 us before transmission starts, and perform the transmission after the successful channel sensing.

### Type 2B Channel Access:

The manner of the channel sensing performed by a communication device is single-sensing slot channel sensing with a fixed length of 16 μs. Specifically, for the Type 2B channel access, the communication device may perform the channel sensing within a sensing slot with 16 us before transmission starts, and perform the transmission after the channel sensing is successful. A length of a gap between a starting position of the transmission and an ending position of the last transmission is 16 μs.

### Type 2C Channel Access:

The communication device performs transmission without performing the channel sensing after a gap ends. Specifically, for the Type 2C channel access, the communication device may directly perform the transmission, but the length of the gap between the starting position of the transmission and the ending position of the last transmission is less than or equal to 16 μs. In addition, the length of the transmission does not exceed 584 μs.

In some optional embodiments of the present disclosure, the synchronization resource of the sidelink of the terminal device may be periodically configured. Furthermore, a sets of synchronization resources may be configured within one synchronization period T milliseconds (ms), and each set of synchronization resources may include the above-mentioned N synchronization slots (also known as the synchronization slot resources), where T and a are positive integers. As an example, T may have values of 20 ms, 40 ms, 80 ms, 160 ms, 320 ms, etc., and a may have values of 1, 2, 3, 4, 5, etc., which is not limited herein.

It is to be noted that in the embodiment of the present disclosure, the redundant synchronization slot resources are increased on the basis of the configuration of the original synchronization slots to obtain the N synchronization slots. That is to say, the terminal device may select available synchronization slot resources among the N synchronization slots to send the synchronization signal, so as to help the terminal device to send sufficient synchronization signals in the case of determining to send the synchronization signal using the synchronization resource, thereby improving the synchronization performance of the sidelink.

In some embodiments, in the operation 210, the network device may configure the synchronization resource of the sidelink for the terminal device, or configure the terminal device to transmit the synchronization signal on the at least part of synchronization slots among the N synchronization slots in the synchronization resource.

For example, the network device may send configuration information to the terminal device, the configuration information is used for configuring the synchronization resources within one synchronization period of the terminal device, or used for configuring the terminal device to transmit the synchronization signal on the at least part of synchronization slots among the N synchronization slots in the synchronization resource. Correspondingly, the terminal device receives the configuration information, and according to the configuration information, the terminal device determines the synchronization resource of the sidelink; or determines that the synchronization signal may be transmitted on the at least part of synchronization slots among the N synchronization slots in the synchronization resource.

Optionally, the configuration information may also be used for configuring the number of synchronization slots supported by the synchronization resource with different sub-carrier spacings. Correspondingly, according to the configuration information, the terminal device determines the number of synchronization slots supported by the synchronization resource with different sub-carrier spacings. For example, the number of synchronization slots may be N mentioned above. For example, N may have a value range of {1, . . . , 1024}. Optionally, N may take one or more values within the value range through configuration, which is not limited herein.

Optionally, the synchronization resource with different sub-carrier spacings supports different numbers of synchronization slots.

As an example, the number of synchronization slots supported in each set of synchronization resources with different sub-carrier spacings in the FR1 is as follows:
15 kHz SCS: {1, 2},
30 KHz SCS: {1, 2, 4},
30 KHz SCS: {1, 2, 4, 6, 8}.

The number of synchronization slots supported in each set of synchronization resources with different sub-carrier spacings in the FR2 is as follows:
60 kHz SCS: {1, 2, 4, 6, 8, 10},
120 KHz SCS: {1, 2, 4, 6, 8, 10, 16, 20, 32, 40, 64, 80}.

As another example, the number of synchronization slots supported in each set of synchronization resources with different sub-carrier spacings in the FR1 is as follows:
15 kHz SCS: {1, 2, 4, 6, 8}.
30 KHz SCS: {1, 2, 4, 6, 8, 10, 16, 20}.
30 kHz SCS: {1, 2, 4, 6, 8, 10, 16, 20, 32, 40}.

The number of synchronization slots supported in each set of synchronization resources with different sub-carrier spacings in the FR2 is as follows:
60 KHz SCS: {1, 2, 4, 6, 8, 10, 16, 20, 32, 40, 64, 80}.
120 KHz SCS: {1, 2, 4, 6, 8, 10, 16, 20, 32, 40, 64, 80, 128, 140}.

In some optional embodiments, the configuration information may also be used for configuring the number of the synchronization resources included in the synchronization period of the sidelink for the terminal device. Correspondingly, according to the configuration information, the terminal device determines the number of synchronization resources included in the synchronization period of the sidelink.

In some optional embodiments, the above configuration information may also be used for configuring a duration T of the synchronization period of the sidelink for the terminal device. Correspondingly, according to the configuration information, the terminal device determines the duration T of the synchronization period of the sidelink.

In some optional embodiments, the configuration information may also be used for configuring the terminal device to send the synchronization signal by occupying M synchronization slots among the N synchronization slots, where M is a positive integer less than or equal to N. That is to say, an additional number (N-M) of the synchronization slot resources, i.e., the redundant synchronization slot resources, may be included in the N synchronization slots.

As a specific example, when one set of synchronization resources is configured with N=6 synchronization slots, the terminal device may send the synchronization signal by occupying M=4 synchronization slots.

Optionally, the number of the synchronization slots for sending the synchronization signal actually occupied by the terminal device may be less than or equal to M, which is not limited in the present disclosure. For example, when the terminal device determines that the number of synchronization slots available to be occupied in one set of synchronization resources is less than M through the LBT, the terminal device may send the synchronization signal based on the actual number of synchronization slots available to be occupied.

Therefore, in the embodiment of the present disclosure, the network device may configure the additional number of synchronization slot resources in the synchronization resource, i.e. the redundant synchronization slot resources for the terminal device, so that the terminal device may send the synchronization signal by occupying M synchronization slots among N synchronization slots.

In other embodiments, when the terminal device is not configured with an M value, the terminal device may send the synchronization information by using N synchronization slots in the synchronization resource described above. In other words, in this case, the terminal device may default to that N is the number of synchronization slots where the synchronization signal is required to be sent.

In other embodiments, in the operation 210, the synchronization resource of the sidelink may be configured in a protocol for the terminal device in advance, or it may be preconfigured in the protocol that the terminal device transmits the synchronization signal on the at least part of synchronization slots among the N synchronization slots in the synchronization resource, which is not limited in the present disclosure.

Optionally, at least one of the following may also be preconfigured in the protocol: a number of synchronization slots supported by the synchronization resource with different sub-carrier spacings, a number of synchronization resources included in a synchronization period of the sidelink, a duration of the synchronization period, or a number M of synchronization slots that are occupied by the terminal device to send the synchronization signal among the N synchronization slots, which is not limited in the present disclosure.

In some optional embodiments, the operation 220 may be specifically implemented in the following manner.

The terminal device determines, according to a result of channel access for an i-th synchronization slot among the N synchronization slots, whether to use the i-th synchronization slot to send the synchronization signal, where i is a positive integer less than or equal to N.

That is to say, in the synchronization resource, the channel access may be independently performed on the synchronization slot resources of the N synchronization slots, i.e., it may be determined, according to a result of channel access for one synchronization slot resource, whether to use the synchronization slot resource for sending the synchronization signal. Exemplarily, before the terminal device uses one synchronization slot resource, the LBT is performed on the synchronization slot resource first, and then according to the result of the LBT performed on the synchronization slot, it is determined whether to send the synchronization signal on the synchronization slot.

Exemplarily, the LBT performed on the i-th synchronization slot may be a long-term LBT or a short-term LBT, which is not limited in the present disclosure. In addition, since the LBT procedure corresponding to each synchronization slot resource is independent, the duration of each LBT procedure performed before each of the synchronization slots may be the same or different, which is not limited in the present disclosure.

As a specific example, the duration of the LBT procedure may be b microseconds (μs), where b is an integer greater than or equal to 0. It is to be noted that b=0 means that LBT is not performed.

As a possible implementation, in a case where the result of the channel access indicates that a channel for the i-th synchronization slot is available, the terminal device determines to use the i-th synchronization slot to send the synchronization signal; otherwise, the terminal device determines not to use the i-th synchronization slot to send the synchronization signal. Exemplarily, when a channel of the synchronization slot is idle, or when the channel energy of the synchronization slot is below a prediction threshold, the synchronization slot may be determined to be available.

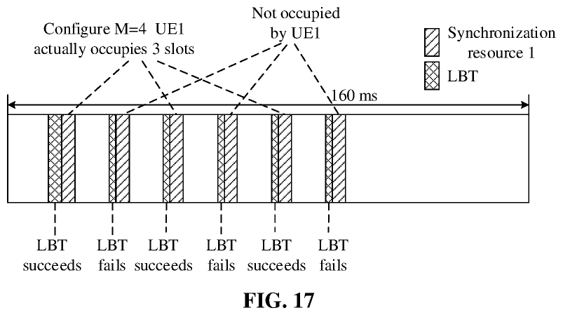

In some embodiments, as shown in FIG. 17 to FIG. 19 below, when the terminal device is configured to send the synchronization signal by occupying M synchronization slots among the N synchronization slots, the terminal device may independently perform the channel access, e.g. the LBT, on each of the N synchronization slots, and determine up to M synchronization slots among the N synchronization slots to send the synchronization signal.

FIG. 17 shows a specific schematic diagram of sending a synchronization signal according to an embodiment of the present disclosure. For example, N=6 synchronization slots are configured in one set of synchronization resources within a synchronization period with 160 ms, and UE1 may send the synchronization signal by occupying M=4 synchronization slots. With reference to FIG. 17, in this embodiment, the UE1 performs the LBT before each synchronization slot resource, and learns that the channel sensing performed on the first synchronization slot, the third synchronization slot and the fifth synchronization slot are successful, i.e., channels of the first synchronization slot, the third synchronization slot and the fifth synchronization slot are available; and that the channel sensing performed on the second synchronization slot, the fourth synchronization slot and the sixth synchronization slot fail, i.e., channels of the second synchronization slot, the fourth synchronization slot and the sixth synchronization slot are busy, then the channels of the first synchronization slot, the third synchronization slot and the fifth synchronization slot may be occupied to send the synchronization signal. Since there are no additional synchronization resources available in the set of synchronization resources within this synchronization period, the UE1 actually occupies 3 synchronization slots to send the synchronization signal. That is to say, in the embodiment of the present disclosure, it is allowed that the number of the synchronization slot resources actually occupied by the terminal device is less than M=4.

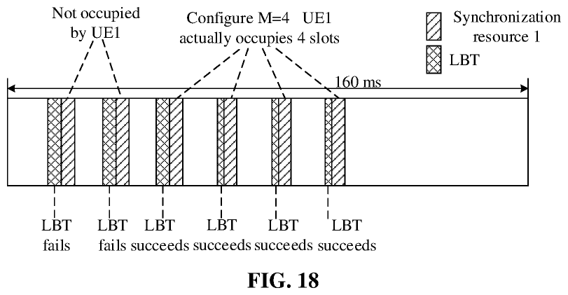

FIG. 18 shows another specific schematic diagram of sending a synchronization signal according to an embodiment of the present disclosure. For example, N=6 synchronization slots are configured in one set of synchronization resources within a synchronization period with 160 ms, and UE1 may send the synchronization signal by occupying M=4 synchronization slots. With reference to FIG. 18, in this embodiment, the UE1 performs the LBT before each synchronization slot resource, and learns that the channel sensing performed on the first synchronization slot and the second synchronization slot fail, i.e., the channels of the first synchronization slot and the second synchronization slot are busy; and that the channel sensing performed on the third synchronization slot, the fourth synchronization slot, the fifth synchronization slot and the sixth synchronization slot are successful, i.e., the channels of the third synchronization slot, the fourth synchronization slot, the fifth synchronization slot and the sixth synchronization slot are available, then the channels of the third synchronization slot, the fourth synchronization slot, the fifth synchronization slot and the sixth synchronization slot may be occupied to send the synchronization signal. During this synchronization period, the number of the synchronization slots for sending the synchronization signal that are actually occupied by the UE1 is the same as the configured available synchronization slots M=4.

In some optional embodiments, in the operation 220, the terminal device sends, according to a result of performing channel access on at least M synchronization slots in the synchronization resource, the synchronization signal by occupying the M synchronization slots among the N synchronization slots; and after the terminal device sends the synchronization signal on the M synchronization slots, the terminal device may determine that the channel access is not performed on a synchronization slot(s) other than the at least M synchronization slots in the synchronization resource, and determine to send the synchronization signal on the synchronization slot(s) other than the at least M synchronization slots. That is to say, when the terminal device determines that sufficient synchronization signals can be sent on a synchronization resource within one synchronization period, the terminal device does not perform the LBT on other synchronization slots in the synchronization resource, and does not send the synchronization signal on other synchronization slots.

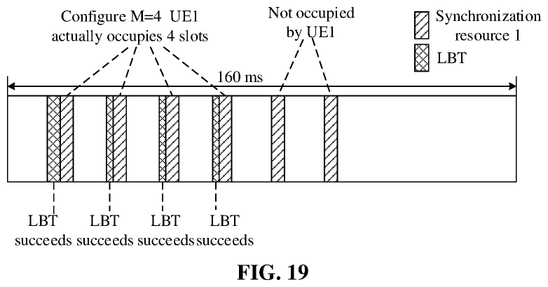

FIG. 19 shows another specific schematic diagram of sending a synchronization signal according to an embodiment of the present disclosure. For example, N=6 synchronization slots are configured in one set of synchronization resources within a synchronization period with 160 ms, and UE1 may send the synchronization signal by occupying M=4 synchronization slots. With reference to FIG. 19, in this embodiment, the UE1 performs the LBT before each synchronization slot resource, and when the UE1 learns that the channel sensing performed on the first synchronization slot, the second synchronization slot, the third synchronization slot and the fourth synchronization slot are successful, i.e., the channels of the first synchronization slot, the second synchronization slot, the third synchronization slot and the fourth synchronization slot are available, then the channels of the first synchronization slot, the second synchronization slot, the third synchronization slot and the fourth synchronization slot may be occupied to send the synchronization signal. During this period, the UE1 does not perform the LBT on the remaining two synchronization slots, i.e. the fifth synchronization slot and the sixth synchronization slot, and does not use them to send the synchronization signal.

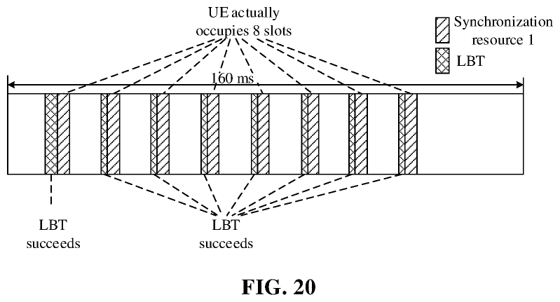

In some embodiments, as shown in FIG. 20 below, when the terminal device is not configured to send the synchronization signal by occupying M synchronization slots among the N synchronization slots, the terminal device may independently perform channel access, e.g. the LBT, on the synchronization slots, and determines up to N synchronization slots among the N synchronization slots to send the synchronization signal, i.e., the terminal device may occupy all the synchronization slots in the synchronization resource to send the synchronization signal by default.

FIG. 20 shows a specific schematic diagram of sending a synchronization signal according to an embodiment of the present disclosure. Exemplarily, N=8 synchronization slots are configured in one set of synchronization resources within a synchronization period with 160 ms. With reference to FIG. 20, in this embodiment, UE1 performs the LBT before each synchronization slot resource, and learns that the channel sensing performed on the first synchronization slot to the eighth synchronization slot are all successful, then the UE1 may send the synchronization signal by occupying the channels of the first synchronization slot to eighth synchronization slot. That is to say, the UE1 sends the synchronization signal by occupying all available synchronization slots.

In other embodiments, if the terminal device finds that the number of available synchronization slots is less than N after performing the LBT on the N synchronization slots, the terminal device may send the synchronization signal based on the number of actually available synchronization slots.

Therefore, in the embodiment of the present disclosure, it may be determined whether to send the synchronization signal on the synchronization slots by independently performing the channel access, such as LBT, on the synchronization slots, which can help the terminal device to flexibly use the synchronization slot resource for sending the synchronization signal, and further help to improve the reliability and the completeness of the synchronization mechanism of the sidelink and improve the system performance.

In some optional embodiments, the operation 220 may be specifically implemented in the following manner.

The terminal device determines, according to a result of channel access for an i-th synchronization slot among the N synchronization slots, whether to send the synchronization signal on the i-th synchronization slot and on L synchronization slots located after the i-th synchronization slot in the synchronization resource, where i and L are positive integers less than or equal to N, and (i+L)≤ N.

That is to say, in the synchronization resource, the channel accesses for the N synchronization slots may be interrelated, i.e., according to the result of the channel access for the synchronization slot resource, it may be determined whether to send the synchronization signal on the synchronization slot resource and on other synchronization slot resources. Exemplarily, the terminal device performs the LBT on a synchronization slot resource, and then the terminal device may determine, according to the result of the LBT performed on the synchronization slot, whether to send the synchronization signal on the synchronization slot and on L synchronization slots located after the synchronization slot.

Exemplarily, the LBT performed on the i-th synchronization slot may be a long-term LBT or a short-term LBT, which is not limited herein. Specifically, the long-term LBT and short-term LBT may refer to the foregoing description, which will not be repeated herein.

In some embodiments, when a number of synchronization slots located after the i-th synchronization slot in the synchronization resource is greater than or equal to (M−1), L=(M−1). When the number of the synchronization slots located after the i-th synchronization slot in the synchronization resource is less than (M−1), L is equal to the number of the synchronization slots located after the i-th synchronization slot in the synchronization resource. Among them, M may refer to the foregoing description, which will not be repeated herein. That is to say, the value of L may be less than or equal to (M−1), so that the terminal device may send the synchronization signal on up to M synchronization slots in the synchronization resource.

In some embodiments, when M is not configured, L is equal to the number of synchronization slots located after the i-th synchronization slot in the synchronization resource, i.e., the terminal device may send the synchronization signal by occupying up to all synchronization slots located after the i-th synchronization slot in the synchronization resource. That is to say, the terminal device may send the synchronization signal on up to N synchronization slots in the synchronization resource by default.

In other embodiments, L may be pre-set, for example, defined in a protocol; or L may be pre-configured by a network device, which is not limited. For example, L may have values of 1, 2, 3, 4, and so on.

As a possible implementation, in a case where the result of the channel access indicates that a channel for the i-th synchronization slot is available, the terminal device determines to send the synchronization signal on the i-th synchronization slot and on the L synchronization slots located after the i-th synchronization slot in the synchronization resource. In a case where the result of the channel access indicates that a channel for the i-th synchronization slot is not available, the terminal device determines not to send the synchronization signal on the i-th synchronization slot.

In some embodiments, an interval between adjacent slots among the N synchronization slots is less than d microseconds, where d is an integer greater than or equal to 0. Exemplarily, d has a value range of {0, 105}. That is to say, when the interval between adjacent slots in the synchronization slots is smaller than a preset value, L synchronization slots located after the i-th synchronization slot in the synchronization resource may not be sensed, i.e., the L synchronization slots may be directly occupied to send the synchronization signal.

In some optional embodiments, after the terminal device determines not to send the synchronization signal on the i-th synchronization slot, it may be determined, according to a result of the channel access for the (i+1)-th synchronization slot (i.e. a synchronization slot located after the i-th synchronization slot) among the N synchronization slots, whether to send the synchronization signal on the (i+1)-th synchronization slot and on synchronization slots located after the i+1-th synchronization slot in the synchronization resource. Specifically, this procedure is similar to the procedure of “determining, according to a result of channel access for an i-th synchronization slot among the N synchronization slots, whether to send the synchronization signal on the i-th synchronization slot and on the synchronization slots located after the i-th synchronization slot in the synchronization resource”, which may refer to the forgoing description, and will not be repeated herein.

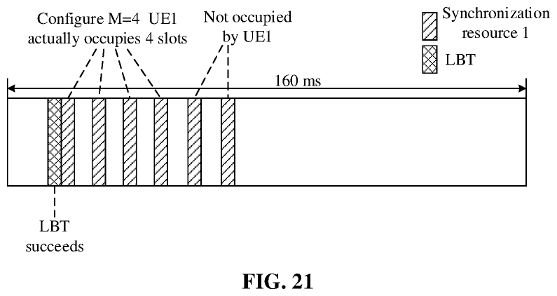

In some embodiments, as shown in FIG. 21 below, when the terminal device is configured to send the synchronization signal by occupying M synchronization slots among the N synchronization slots, the terminal device may associate the channel accesses, e.g. LBTs, performed on the synchronization slots, and determine up to M synchronization slots to send the synchronization signal.

FIG. 21 shows a specific schematic diagram of sending a synchronization signal according to an embodiment of the present disclosure. For example, N=6 synchronization slots are configured in one set of synchronization resources within a synchronization period with 160 ms. UE1 may send the synchronization signal by occupying M−4 synchronization slots, and the interval between synchronization slots is d=16 us or 32 μs. With reference to FIG. 21, in this embodiment, the UE1 performs the LBT before the first synchronization slot resource, and learns that the channel sensing performed on the first synchronization slot is successful, i.e., the UE1 may send the synchronization signal by occupying channels of the first synchronization slot to the fourth synchronization slot. Herein, the UE1 does not perform the LBT on the remaining fifth synchronization slot and sixth synchronization slot, and does not send the synchronization signal by occupying the fifth synchronization slot and sixth synchronization slot. During this synchronization period, the number of the synchronization slots for sending the synchronization signal that are actually occupied by the UE1 is the same as the configured available synchronization slots M=4.

Optionally, in other examples, if the UE1 fails in the LBT on the first synchronization slot and succeeds in the LBT on the second synchronization slot, then the UE1 may send the synchronization signal by occupying the second synchronization slot to fifth synchronization slot. For another example, if the UE1 fails in the LBT on the first synchronization slot and the second synchronization slot and succeeds in the LBT on the third synchronization slot, then the UE1 may send the synchronization signal by occupying the third synchronization slot to the sixth synchronization slot, and so on.

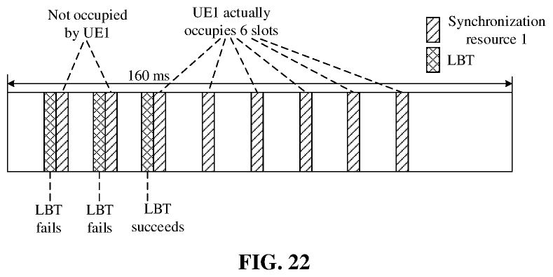

In some embodiments, as shown in FIG. 22 below, when the terminal device is not configured to send the synchronization signal by occupying M synchronization slots among the N synchronization slots, the terminal device may associate the channel accesses, e.g. the LBTs, performed on the synchronization slots, and determine up to N synchronization slots to send the synchronization signal, i.e., the terminal device may occupy all the synchronization slots in the synchronization resource to send the synchronization signal by default.

FIG. 22 shows a specific schematic diagram of sending a synchronization signal according to an embodiment of the present disclosure. For example, N=8 synchronization slots are configured in one set of synchronization resources within a synchronization period with 160 ms and the interval between the synchronization slots is d=16 us or 32 μs. With reference to FIG. 22, in this embodiment, If the UE1 performs the LBT before the first synchronization slot resource and the second synchronization slot resource, and learns that the channel sensing performed on the first synchronization slot and the second synchronization slot fail; and UE1 performs the LBT before the third synchronization slot resources, and learns that the channel sensing performed on the third synchronization slot is successful, then the synchronization slots (i.e., the third synchronization slot to the eighth synchronization slot) located after the third synchronization slot in the synchronization resource may be directly used for sending the synchronization signal, without LBT.

Optionally, in other examples, if UE1 succeeds in the LBT on the first synchronization slot, then the UE1 may send the synchronization signal by occupying the first synchronization slot to the eighth synchronization slot. For example, if the LBT performed on the first synchronization slot is failed and the LBT performed on the second synchronization slot is successful, then the UE1 may send the synchronization signal by occupying the second synchronization slot to eighth synchronization slot, and so on.

As a possible implementation, the operation that the terminal device determines, according to the result of the channel access for the i-th synchronization slot among the N synchronization slots, whether to send the synchronization signal on the i-th synchronization slot and on the L synchronization slots located after the i-th synchronization slot in the synchronization resource may specifically include that:
in a case where the result of the channel access obtained in a first channel access manner indicates that a channel for the i-th synchronization slot is available, it is determined to send the synchronization signal on the i-th synchronization slot; and
it is determined, according to a result of channel access for an (i+j)-th synchronization slot among the N synchronization slots in a second channel access manner, whether to send the synchronization signal on the (i+j)-th synchronization slot, where j is a positive integer less than or equal to N, and j≤ L.

That is to say, it may be determined whether to send the synchronization signal on the i-th synchronization slot and on the subsequent L synchronization slots by combining the first channel access manner and the second channel access manner. For example, in a case where the result of the channel access obtained in a first channel access manner indicates that a channel for the i-th synchronization slot is available, the channel access may be performed, in the second channel access manner, on the synchronization slot located after the i-th synchronization slot in the synchronization resource, so as to determine whether to send the synchronization signal on the synchronization slot located after the i-th synchronization slot.

In some embodiments, the interval between adjacent slots among the N synchronization slots is not limited. Exemplarily, the interval between adjacent slots among the N synchronization slots may be greater than d microseconds or less than d microseconds.

In some optional embodiments, the first channel access manner includes a first LBT manner, and the second channel access manner includes a second LBT manner, a duration of the first LBT manner being longer than a duration of the second LBT. Exemplarily, the first LBT may be a long-term LBT and the second LBT may be a short-term LBT, which may refer to the foregoing description in detail and will not be repeated herein.

In other optional embodiments, in a case where the result of the channel access obtained in a first channel access manner indicates that a channel for the i-th synchronization slot is busy (i.e., the channel access for the i-th synchronization slot is failed), it is determined not to send the synchronization signal on the i-th synchronization slot. In this case, it is possible to determine, according to the result of the channel access for a (i+1)-th synchronization slot among the N synchronization slots, whether to send the synchronization signal on the (i+1)-th synchronization slot and on the synchronization slots located after the (i+1)-th synchronization slot in the synchronization resource. Specifically, the procedure herein is similar to the procedure of “determining, according to the result of the channel access for the i-th synchronization slot, whether to send the synchronization signal on the i-th synchronization slot and on the synchronization slots located after the i-th synchronization slot in the synchronization resource”, which may refer to the foregoing description in detail and will not be repeated herein.

As a possible implementation, the operation that “it is determined, according to the result of the channel access for the (i+j)-th synchronization slot among the N synchronization slots in the second channel access manner, whether to send the synchronization signal on the (i+j)-th synchronization slot” may specifically include that:
in a case where the result of the channel access obtained in the second channel access manner indicates that a channel for the (i+j)-th synchronization slot is available, it is determined to send the synchronization signal on the (i+j)-th synchronization slot 1; otherwise,
in a case where the result of the channel access obtained in the second channel access manner indicates that a channel for the (i+j)-th synchronization slot is not available, the terminal device determines to send the synchronization signal on the (i+j)-th synchronization slot.

That is to say, in the case where the result of the channel access obtained in a first channel access manner indicates that a channel for the i-th synchronization slot is available, and the channel access is performed on the synchronization slot located after the i-th synchronization slot in the synchronization resource in the second channel access manner, if the result of the channel access indicates that the channel of the synchronization slot located after the i-th synchronization slot is available, then it may be determined to send the synchronization signal on the synchronization slot located after the i-th synchronization slot. Otherwise, if the result of the channel access indicates that the channel for the (i+j)-th synchronization slot is busy (i.e., the channel access is failed), then the terminal device does not send the synchronization signal on the (i+j)-th synchronization slot.

In some optional embodiments, if the result of the channel access obtained in the second channel access manner indicates that the channel for the (i+j)-th synchronization slot is busy (i.e. the channel access is failed), it may be determined, according to the result of the channel access for an (i+j+1)-th synchronization slot among the N synchronization slots, whether to send the synchronization signal on the (i+j+1)-th synchronization slot and on the synchronization slots located after the (i+j+1)-th synchronization slot in the synchronization resource. Specifically, the procedure herein is similar to the procedure of “determining, according to the result of the channel access for the i-th synchronization slot, whether to send the synchronization signal on the i-th synchronization slot and on the synchronization slots located after the i-th synchronization slot in the synchronization resource”, which may refer to the foregoing description in detail and will not be repeated herein.

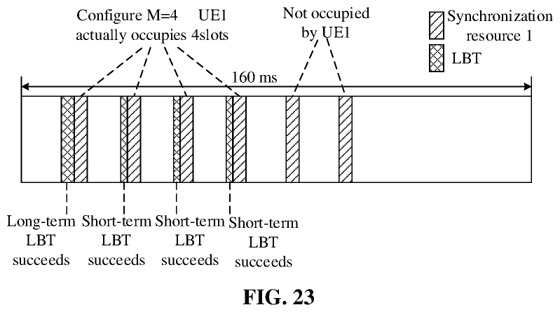

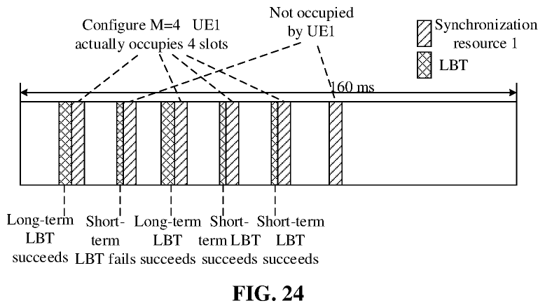

In some embodiments, as shown in FIG. 23 and FIG. 24 below, when the terminal device is configured to send the synchronization signal by occupying M synchronization slots among the N synchronization slots, the terminal device may associate the channel accesses, e.g. LBTs that may further include the long-term LBT and the short-term LBT, performed on the synchronization slots, and determine up to M synchronization slots among the N synchronization slots to send the synchronization signal.

FIG. 23 shows a specific schematic diagram of sending a synchronization signal according to an embodiment of the present disclosure. For example, N=6 synchronization slots are configured in one set of synchronization resources within a synchronization period with 160 ms, and UE1 may send the synchronization signal by occupying M=4 synchronization slots. With reference to FIG. 23, in this embodiment, if the UE1 succeeds in the long-term LBT on the first synchronization slot resource and succeeds in short-term LBTs on the subsequent second synchronization slot to the fourth synchronization slot, then the UE1 may send the synchronization signal by occupying the channels of the first synchronization slot to the fourth synchronization slot. Herein, the UE1 does not perform the LBT on the remaining fifth synchronization slot and sixth synchronization slot, and does not send the synchronization signal by occupying the fifth synchronization slot and sixth synchronization slot. During this synchronization period, the number of the synchronization slots for sending the synchronization signal that are actually occupied by the UE1 is the same as the configured available synchronization slots M=4.

Optionally, in other examples, if the UE1 fails in the long-term LBT on the first synchronization slot and succeeds in the long-term LBT on the second synchronization slot, then the UE1 may perform the short-term LBT on the third synchronization slot to the fifth synchronization slot, and if the short-term LBT performed on each of the third synchronization slot to the fifth synchronization slot is successful, then the UE1 may send the synchronization signal by using the second synchronization slot to the fifth synchronization slot. For another example, if the UE1 fails in the long-term LBTs on the first synchronization slot and the second synchronization slot and succeeds in the long-term LBT on the third synchronization slot, then the UE1 may perform the short-term LBT on the fourth synchronization slot to the sixth synchronization slot. If the short-term LBT performed on each of the fourth synchronization slot to the sixth synchronization slot is successful, then the UE1 may send synchronization signal by using the third synchronization slot to the sixth synchronization slot, and so on.

FIG. 24 shows another specific schematic diagram of sending a synchronization signal according to an embodiment of the present disclosure. For example, N=6 synchronization slots are configured in one set of synchronization resources within a synchronization period with 160 ms, and UE1 may send the synchronization signal by occupying M=4 synchronization slots. With reference to FIG. 24, in this embodiment, if the UE1 succeeds in the long-term LBT on the first synchronization slot resource, then the UE1 may send the synchronization signal by occupying the channel of the first synchronization slot and perform the short-term LBT on the second synchronization slot. If the short-term LBT performed on the second synchronization slot is failed, then the UE1 may continue to perform the long-term LBT on the third synchronization slot. If the long-term LBT performed on the third synchronization slot is successful, then the UE1 may send the synchronization signal by occupying the channel of the third synchronization slot and perform the short-term LBT on the fourth synchronization slot. By analogy, if the UE1 succeeds in the short-term LBTs on the fourth synchronization slot and the fifth synchronization slot, then the UE1 may send the synchronization signal by using the fourth synchronization slot and the fifth synchronization slot. Herein, the UE1 does not perform the LBT on the remaining sixth synchronization slot, and does not send the synchronization signal by occupying the sixth synchronization slot. During this synchronization period, the number of the synchronization slots for sending the synchronization signal that are actually occupied by the UE1 is the same as the configured available synchronization slots M=4.

Optionally, in other examples, if the UE1 fails in the long-term LBT on the first synchronization slot and succeeds in the long-term LBT on the second synchronization slot, then the UE1 may send the synchronization signal in the second synchronization slot to the fifth synchronization slot in the manner shown in FIG. 24. For another example, if the UE1 fails in the long-term LBTs on the first synchronization slot and the second synchronization slot and succeeds in the long-term LBT on the third synchronization slot, then the UE1 may send the synchronization signal in the third synchronization slot to the sixth synchronization slot as shown in FIG. 24. If the UE1 fails in the long-term LBTs on the first synchronization slot, the second synchronization slot, the third synchronization slot and the fourth synchronization slot and succeeds in the long-term LBT on the fifth synchronization slot, then the UE1 may send the synchronization signal in the fifth synchronization slot to the sixth synchronization slot in the manner shown in FIG. 24, and so on. Optionally, in some embodiments, the number of the synchronization slots for sending the synchronization signal that are actually occupied by the UE1 may be less than the configured available synchronization slots M=4.

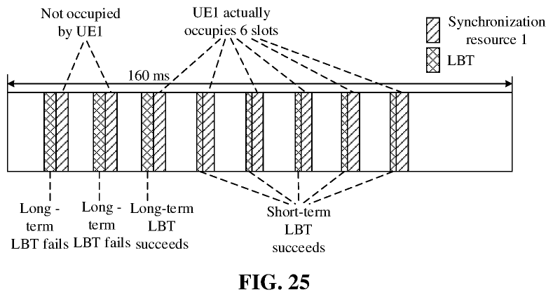

In some embodiments, as shown in FIG. 25 below, when the terminal device is not configured to send the synchronization signal by occupying M synchronization slots among the N synchronization slots, the terminal device may associate the channel accesses, e.g. LBTs that may further include the long-term LBT and the short-term LBT, performed on the synchronization slots, and determine up to M synchronization slots among the N synchronization slots to send the synchronization signal. That is to say, the terminal device may occupy all the synchronization slots in the synchronization resource to send the synchronization signal by default.

FIG. 25 shows a specific schematic diagram of sending a synchronization signal according to an embodiment of the present disclosure. Exemplarily, N=8 synchronization slots are configured in one set of synchronization resources within a synchronization period with 160 ms. With reference to FIG. 25, in this embodiment, if the UE1 fails in the long-term LBTs on the first synchronization slot and the second synchronization slot and succeeds in the long-term LBT on the third synchronization slot, then the short-term LBT may be performed on the fourth synchronization slot and subsequent synchronization slots (i.e., the fourth synchronization slot to the eighth synchronization slot) in the synchronization resource. If the short-term LBT performed on each of the subsequent fourth synchronization slot to the eighth synchronization slot is successful, then channels of the third synchronization slot to the eighth synchronization slot may be occupied to send the synchronization signal.

Optionally, in other examples, if the UE1 succeeds in the long-term LBT on the first synchronization slot, then the UE1 may perform the short-term LBTs on the second synchronization slot to the eighth synchronization slot. If the short-term LBT performed on each of the subsequent second synchronization slot to the eighth synchronization slot is successful, then the synchronization signal can be sent by occupying the first synchronization slot to the eighth synchronization slot, i.e., the synchronization signal may be sent in the manner shown in FIG. 25. For another example, if the long-term LBT performed on the first synchronization slot is failed and the long-term LBT performed on the second synchronization slot is successful then the UE1 may send the synchronization signal in the manner shown in FIG. 25, and so on.

Therefore, according to the embodiment of the present disclosure, the channel accesses, e.g. LBTs or for a further example, the long-term LBT and the short-term LBT, performed on the synchronization slots may be associated to determine whether to use the synchronization slots to send the synchronization signal, which can help the terminal device to flexibly use the synchronization slot resource to send the synchronization signal, and further help to improve the reliability and the completeness of the synchronization mechanism of the sidelink and improve the system performance.

In some optional embodiments, the N synchronization slots may include a first synchronization slot and a second synchronization slot. The operation 220 may be implemented in the following manners.

The terminal device determines, according to a result of channel access for the first synchronization slot, whether to send the synchronization signal on the first synchronization slot; and in a case where the first synchronization slot does not satisfy a requirement for sending the synchronization signal, the terminal device determines to send the synchronization signal on the second synchronization slot.

Herein, the fact that the first synchronization slot does not satisfy the requirement for sending the synchronization signal may include: a case where each of the synchronization slots in the first synchronization slot is found to be unavailable through the LBT, or a case where only a part of synchronization slots in the first synchronization slot may be used for sending the synchronization signal through the LBT, but the use of the part of synchronization slots is insufficient to satisfy the requirement for the terminal device to send the synchronization signal.

Exemplarily, the N synchronization slots may include X first synchronization slots and Y second synchronization slots, where X and Y are integers greater than or equal to 0, i.e., N=X+Y. That is to say, N+Y synchronization slots may be included in one set of synchronization resources. As an example, it may be determined, according to a result of channel access for each of the X synchronization slots, whether to send the synchronization signal on the X synchronization slots. When the X synchronization slots does not satisfy the requirement for the terminal device to send the synchronization signal, a part of or all of (e.g. one or more) synchronization slots may be selected from the Y synchronization slots to send the synchronization signal. That is to say, the second synchronization slot may be used as standby synchronization slots to send the synchronization signal. Specifically, the procedure of determining, according to the result of the channel access for the first synchronization slot, whether to send the synchronization signal on the first synchronization slot may refer to the foregoing description, which will not be repeated herein.

In some optional embodiments, in a case where the result of the channel access obtained by performing the channel access on the second synchronization slot indicates that the channel of the second synchronization slot is available, it is determined to send the synchronization signal on the second synchronization slot. For example, for the above-mentioned Y synchronization slots, the synchronization signal may be sent in the synchronization slot(s) where the LBT (e.g. the long-term LBT or the short-term LBT) is successful.

In other optional embodiments, for the above-mentioned second synchronization slot, the synchronization signal may be sent by directly using the second synchronization slot without performing the LBT, which is not limited herein.

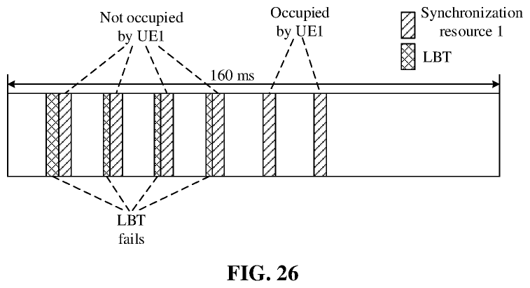

FIG. 26 shows a specific schematic diagram of sending a synchronization signal according to an embodiment of the present disclosure. Exemplarily, N=6 synchronization slots are configured in one set of synchronization resources within a synchronization period with 160 ms, where the N=6 synchronization slots includes X=2 first synchronization slots and Y=2 second synchronization slots. With reference to FIG. 26, in this embodiment, when the UE1 fails in the LBT before the first synchronization slot resource to the fourth synchronization slot resource, then the UE1 may not perform the LBT on the fifth synchronization slot and the sixth synchronization slot, but send the synchronization signal by directly occupying the fifth synchronization slot and the sixth synchronization slot.

Therefore, according to the embodiment of the present disclosure, standby synchronization slots are set in the synchronization resource, so as to directly send the synchronization signal in the case where the synchronization slots that are used for sending the synchronization signal and obtained through the manner of LBT are insufficient, which can satisfy the requirement for the terminal device to send sufficient synchronization signals, and further help to improve the reliability and the completeness of the synchronization mechanism of the sidelink and improve the system performance.

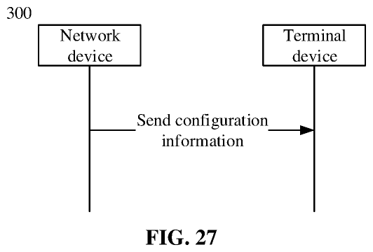

FIG. 27 is a schematic flowchart of a method 300 for wireless communication according to an embodiment of the present disclosure. As shown in FIG. 27, the method 300 may include at least some of the following contents.

In operation 310, a network device sends configuration information to a terminal device. The configuration information is used for configuring the terminal device to send a synchronization signal by occupying at least part of synchronization slots among N synchronization slots in a synchronization resource, where N is a positive integer.

In some optional embodiments, N has a value range of {1, . . . , 1024}.

In some optional embodiments, the N synchronization slots include a first synchronization slot and a second synchronization slot.

The second synchronization slot is used for sending the synchronization signal in a case where the first synchronization slot dose not satisfy a requirement for sending the synchronization signal by the terminal device.

In some optional embodiments, the configuration information is further used for configuring at least one of: a number of synchronization slots supported by the synchronization resource with different sub-carrier spacings, a number of synchronization resources included in a synchronization period of the sidelink, a duration of the synchronization period, or a number M of synchronization slots that are occupied by the terminal device to send the synchronization signal among the N synchronization slots, where M is a positive integer less than or equal to N.

It should be understood that the operations in method 300 may refer to the description of the corresponding operations in method 200 above, which will not be repeated herein in order to avoid repetition.

Specific embodiments of the present disclosure have been described in detail with reference to the accompanying drawings, but the present disclosure is not limited to the specific details of the above embodiments. Within the scope of the technical conception of the present disclosure, various simple modifications may be made to the technical scheme of the present disclosure, and these simple modifications all fall within the scope of protection of the present disclosure. For example, each of the specific technical features described in the above specific embodiments may be combined in any suitable manner without contradiction, and various possible combinations are not further described in this disclosure in order to avoid unnecessary repetition. For another example, any combination may be made between the various embodiments of the present disclosure so long as it does not depart from the idea of the present disclosure and is also to be regarded as the present disclosure of the present disclosure. For another example, on the premise of no conflict, each embodiment described in the present disclosure and/or the technical features in each embodiment may be arbitrarily combined with the prior art, and the technical scheme obtained after the combination should also fall within the scope of protection of the present disclosure.

It is to be understood that, in various embodiments of the present disclosure, the sequence numbers of the above processes do not imply the sequence of execution, and the sequence of execution of each process should be determined according to its functions and internal logic, and should not constitute any limitation on the implementation process of the embodiments of the present disclosure.

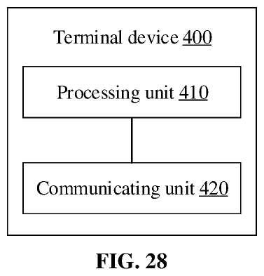

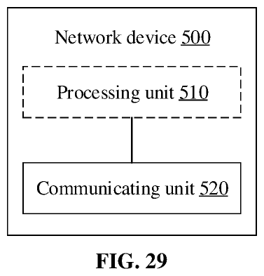

The method embodiments of the present disclosure are described in detail above and the apparatus embodiments of the present disclosure are described in detail below with reference to FIG. 28 to FIG. 29. It is to be understood that the apparatus embodiments correspond to the method embodiments, and similar descriptions thereof may refer to the method embodiments.

FIG. 28 shows a schematic block diagram of a terminal device 400 according to an embodiment of the present disclosure. As shown in FIG. 28, the terminal device 400 includes a processing unit 410 and a communicating unit 420.

The processing unit 410 is configured to determine a synchronization resource of a sidelink, where the synchronization resource includes N synchronization slots, and N is a positive integer.

The communicating unit 420 is configured to send, according to a result of performing channel access on the synchronization resource, a synchronization signal by occupying at least part of synchronization slots among the N synchronization slots.

In some optional embodiments, the communicating unit 420 is specifically configured to:

determine, according to a result of channel access for an i-th synchronization slot among the N synchronization slots, whether to send the synchronization signal on the i-th synchronization slot, where i is a positive integer less than or equal to N.

In some optional embodiments, the communicating unit 420 is specifically configured to:
in a case where the result of the channel access indicates that a channel for the i-th synchronization slot is available, determine to send the synchronization signal on the i-th synchronization slot; otherwise
determine not to send the synchronization signal on the i-th synchronization slot.

In some optional embodiments, the communicating unit 420 is specifically configured to:

determine, according to a result of channel access for an i-th synchronization slot among the N synchronization slots, whether to send the synchronization signal on the i-th synchronization slot and on L synchronization slots located after the i-th synchronization slot in the synchronization resource, where i and L are positive integers less than or equal to N, and (i+L)≤ N.

In some optional embodiments, the communicating unit 420 is specifically configured to:
in a case where the result of the channel access indicates that a channel for the i-th synchronization slot is available, determine to send the synchronization signal on the i-th synchronization slot and on the L synchronization slots; otherwise
determine not to send the synchronization signal on the i-th synchronization slot.

In some optional embodiments, an interval between adjacent slots among the N synchronization slots is less than d microseconds, where d is an integer greater than or equal to 0.

In some optional embodiments, d has a value range of {0, 105}.

In some optional embodiments, the communicating unit 420 is specifically configured to:
in a case where the result of the channel access obtained in a first channel access manner indicates that a channel for the i-th synchronization slot is available, determine to send the synchronization signal on the i-th synchronization slot; and
determine, according to a result of channel access for an (i+j)-th synchronization slot among the N synchronization slots in a second channel access manner, whether to send the synchronization signal on the (i+j)-th synchronization slot, where j is a positive integer less than or equal to N, and j≤ L.

In some optional embodiments, the communicating unit 420 is specifically configured to:
in a case where the result of the channel access obtained in the second channel access manner indicates that a channel for the (i+j)-th synchronization slot is available, determine to send the synchronization signal on the (i+j)-th synchronization slot; otherwise
determine not to send the synchronization signal on the (i+j)-th synchronization slot.

In some optional embodiments, the first channel access manner includes a first Listen Before Talk (LBT) manner, and the second channel access manner includes a second LBT manner, a duration of the first LBT manner being longer than a duration of the second LBT.

In some optional embodiments, when a number of synchronization slots located after the i-th synchronization slot in the synchronization resource is greater than or equal to (M−1), L=(M−1); and
when the number of the synchronization slots located after the i-th synchronization slot in the synchronization resource is less than (M−1), L is equal to the number of the synchronization slots located after the i-th synchronization slot in the synchronization resource,
where M represents a number of synchronization slots, that are configured for the terminal device and available for sending the synchronization signal, among the N synchronization slots, and M is a positive integer less than or equal to N.

In some optional embodiments, the communicating unit 420 is specifically configured to:
send, according to a result of performing channel access on at least M synchronization slots in the synchronization resource, the synchronization signal by occupying the M synchronization slots among the N synchronization slots; and
after the terminal device sends the synchronization signal on the M synchronization slots, determine that the channel access is not performed on a synchronization slot other than the at least M synchronization slots in the synchronization resource, and determine to send the synchronization signal on the synchronization slot other than the at least M synchronization slots,
where M represents a number of synchronization slots, that are configured for the terminal device and available for sending the synchronization signal, among the N synchronization slots, and M is a positive integer less than or equal to N.

In some optional embodiments, the N synchronization slots include a first synchronization slot and a second synchronization slot.

The communicating unit 420 is specifically configured to:
determine, according to a result of channel access for the first synchronization slot, whether to send the synchronization signal on the first synchronization slot; and
in a case where the first synchronization slot does not satisfy a requirement for sending the synchronization signal, determine to send the synchronization signal on the second synchronization slot.

In some optional embodiments, the communicating unit 420 is specifically configured to:

in a case where a result of channel access obtained by performing the channel access on the second synchronization slot indicates that a channel for the second synchronization slot is available, determine to send the synchronization signal on the second synchronization slot.

In some optional embodiments, N has a value range of {1, . . . , 1024}.

In some optional embodiments, the communicating unit 420 is specifically configured to:

receive configuration information, where the configuration information is used for configuring the terminal device to send the synchronization signal by occupying the at least part of the synchronization slots among the N synchronization slots.

In some optional embodiments, the configuration information is further used for configuring at least one of: a number of synchronization slots supported by the synchronization resource with different sub-carrier spacings, a number of synchronization resources included in a synchronization period of the sidelink, a duration of the synchronization period, or a number M of synchronization slots that are occupied by the terminal device to send the synchronization signal among the N synchronization slots, where M is a positive integer less than or equal to N.

In some optional embodiments, at least one of the following is pre-configured in a protocol: a number of synchronization slots supported by the synchronization resource with different sub-carrier spacings, a number of synchronization resources included in a synchronization period of the sidelink, a duration of the synchronization period, or a number M of synchronization slots that are occupied by the terminal device to send the synchronization signal among the N synchronization slots, where M is a positive integer less than or equal to N.

In some embodiments, the communicating unit may be a communication interface or a transceiver, or an input-output interface of a communication chip or a system-on-chip. The processing unit may be one or more processors.

It is to be understood that the terminal device 400 in the embodiments of the present disclosure may correspond to the terminal device in the method embodiments of the present disclosure, and the above and other operations and/or functions of the units in the terminal device 400 are intended to implement the corresponding flow of the terminal device in the method 200 for wireless communication illustrated in FIG. 16, respectively, which will not be elaborated herein for the sake of brevity.

FIG. 29 shows a schematic block diagram of a network device 500 according to an embodiment of the present disclosure. As shown in FIG. 29, the network device 500 includes a communicating unit 520.

The communicating unit 520 is configured to send configuration information to a terminal device, where the configuration information is used for configuring the terminal device to send a synchronization signal by occupying at least part of synchronization slots among N synchronization slots in a synchronization resource, where N is a positive integer.

Optionally, the network device may also include a processing unit 510 configured to determine the configuration information.

In some optional embodiments, N has a value range of {1, . . . , 1024}.

In some optional embodiments, the N synchronization slots include a first synchronization slot and a second synchronization slot;

where the second synchronization slot is used for sending the synchronization signal in a case where the first synchronization slot dose not satisfy a requirement for sending the synchronization signal by the terminal device.

In some optional embodiments, the configuration information is further used for configuring at least one of: a number of synchronization slots supported by the synchronization resource with different sub-carrier spacings, a number of synchronization resources included in a synchronization period of the sidelink, a duration of the synchronization period, or a number M of synchronization slots that are occupied by the terminal device to send the synchronization signal among the N synchronization slots, where M is a positive integer less than or equal to N.

In some embodiments, the communicating unit may be a communication interface or a transceiver, or an input-output interface of a communication chip or a system-on-chip. The processing unit may be one or more processors.

It is to be understood that the network device 500 in the embodiments of the present disclosure may correspond to the network device in the method embodiments of the present disclosure, and the above and other operations and/or functions of the units in the network device 500 are intended to implement the corresponding flow of the network device in the method 300 for wireless communication illustrated in FIG. 27, respectively, which will not be elaborated herein for brief description.

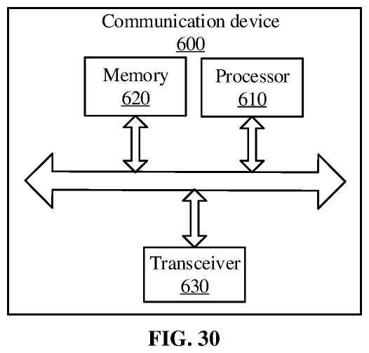

FIG. 30 is a schematic structural diagram of a communication device 600 according to an embodiment of the present disclosure. The communication device 600 illustrated in FIG. 30 includes a processor 610. The processor 610 may invoke and run a computer program from a memory to implement the method in the embodiments of the present disclosure.

In some embodiments, as shown in FIG. 30, the communication device 600 may also include a memory 620. The processor 610 may invoke and run a computer program from the memory 620 to implement the method in the embodiments of the present disclosure.

The memory 620 may be a separate device independent of the processor 610 or the memory 620 may be integrated into the processor 610.

In some embodiments, as shown in FIG. 30, the communication device 600 may also include a transceiver 630. The processor 610 may control the transceiver 630 to communicate with other devices, and in particular, to send information or data to other devices, or receive information or data sent by other devices.

The transceiver 630 may include a transmitter and a receiver. The transceiver 630 may further include an antenna(s), the number of which may be one or more.

In some embodiments, the communication device 600 may be specifically the network device in the embodiments of the present disclosure, and the communication device 600 may implement the corresponding process implemented by the network device in each method of the embodiments of the present disclosure, which will not be repeated herein for the sake of brevity.

In some embodiments, the communication device 600 may be the terminal device according to the embodiments of the present disclosure, and the communication device 600 may implement the corresponding flow implemented by the terminal device in each method of the embodiments of the present disclosure, which will not be repeated herein for the sake of brevity.

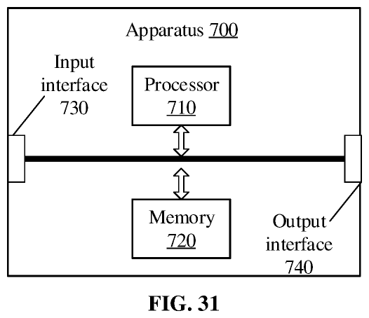

FIG. 31 is a schematic structural diagram of an apparatus according to an embodiment of the present disclosure. The apparatus 700 shown in FIG. 31 includes a processor 710 that may invoke and run a computer program from a memory to implement the method in the embodiments of the present disclosure.

In some embodiments, as shown in FIG. 31, the apparatus 700 may also include a memory 720. The processor 710 may invoke and run a computer program from the memory 720 to implement the method in the embodiments of the present disclosure.

The memory 720 may be a separate device independent of the processor 710 or the memory 720 may be integrated in the processor 710.

In some embodiments, the apparatus 700 may also include an input interface 730. The processor 710 may control the input interface 730 to communicate with other devices or chips, and in particular may obtain information or data sent by other devices or chips.

In some embodiments, the apparatus 700 may also include an output interface 740. The processor 710 may control the output interface 740 to communicate with other devices or chips, and in particular may output information or data to other devices or chips.

In some embodiments, the apparatus may be applied to the network device in the embodiments of the present disclosure, and the apparatus may implement the corresponding process implemented by the network device in each method of the embodiments of the disclosure, which is not repeated herein for the sake of brevity.

In some embodiments, the apparatus may be applied to the terminal device in the embodiments of the present disclosure, and the chip may implement the corresponding flow implemented by the terminal device in each method of the embodiment of the disclosure, which will not be repeated herein for the sake of brevity.

In some embodiments, the apparatus mentioned in the embodiments of the present disclosure may also be a chip, which, for example, may be a system level chip, a system chip, a chip system or an on-chip system chip, etc.

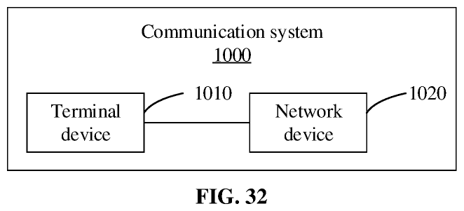

FIG. 32 is a schematic block diagram of a communication system 1000 according to an embodiment of the present disclosure. As shown in FIG. 32, the communication system 1000 includes a terminal device 1010 and a network device 1020.

The terminal device 1010 may be configured to implement the corresponding functions implemented by the terminal device in the above-mentioned method, and the network device 1020 may be configured to implement the corresponding functions implemented by the network device in the above-mentioned method, which will not be repeated herein for the sake of brevity.

It is to be understood that the processor of the embodiments of the disclosure may be an integrated circuit chip with signal processing capacity. In an implementation process, various steps of the above method embodiments may be completed by an integrated logic circuit of hardware in the processor or an instruction in the form of software. The above processor may be a general-purpose processor, a Digital Signal Processor (DSP), an Application Specific Integrated Circuit (ASIC), a Field Programmable Gate Array (FPGA), or other programmable logic devices, discrete gate or transistor logic devices, and discrete hardware components. Various methods, steps, and logical block diagrams disclosed in the embodiments of the disclosure may be implemented or performed. The general-purpose processor may be a microprocessor, any conventional processor, or the like. Steps of the methods disclosed with reference to the embodiments of the disclosure may be directly performed and accomplished by a hardware decoding processor, or may be performed and accomplished by a combination of hardware and software modules in the decoding processor. The software module may be located in a storage medium mature in the art, such as a random access memory, a flash memory, a read-only memory, a programmable read-only memory or electrically erasable programmable memory, or a register. The storage medium is located in the memory, and the processor reads information in the memory and completes the steps in the foregoing methods in combination with hardware of the processor.

It may be understood that the memory in the embodiments of the disclosure may be a volatile memory or a nonvolatile memory, or may include a volatile memory and a nonvolatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a RAM, which is used as an external high-speed cache. By way of example but not restrictive description, many forms of RAMs may be used, for example, a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), and a Direct Rambus RAM (DR RAM). It is to be noted that the memory of the systems and methods described in this specification includes but is not limited to these and any other proper types of memories.

It is to be understood that the abovementioned memories are exemplary but not restrictive, for example, the memory in the embodiments of the disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a Direct Rambus RAM (DR RAM). That is to say, the memories described in the embodiment of the disclosure are intended to include, but not limited to, these and any other suitable types of memories.

The embodiments of the disclosure further provide a computer-readable storage medium, which is configured to store a computer program.

In some embodiments, the computer-readable storage medium may be applied to the network device in the embodiments of the disclosure. The computer program enables a computer to execute corresponding flows implemented by the network device in each method of the embodiments of the disclosure, which will not be elaborated here for simplicity.

In some embodiments, the computer-readable storage medium may be applied to the terminal device in the embodiments of the disclosure. The computer program enables a computer to execute corresponding flows implemented by the terminal device in each method of the embodiments of the disclosure, which will not be elaborated here for simplicity.

The embodiments of the disclosure further provide a computer program product, which includes a computer program instruction.

In some embodiments, the computer program product may be applied to a network device in the embodiments of the disclosure. The computer program instruction enables a computer to execute corresponding flows implemented by the network device in each method of the embodiments of the disclosure, which will not be elaborated here for simplicity.

In some embodiments, the computer program product may be applied to the terminal device in the embodiments of the disclosure. The computer program instruction enables a computer to execute corresponding flows implemented by the terminal device in each method of the embodiments of the disclosure, which will not be elaborated herein for simplicity.

The embodiments of the disclosure further provide a computer program.

In some embodiments, the computer program may be applied to a network device in the embodiments of the disclosure. The computer program runs in a computer to enable the computer to execute corresponding flows implemented by the network device in each method of the embodiments of the disclosure, which will not be elaborated herein for simplicity.

In some embodiments, the computer program may be applied to the terminal device in the embodiments of the disclosure. When running on a computer, the computer program enables a computer to execute corresponding flows implemented by the terminal device in each method of the embodiments of the disclosure, which will not be elaborated here for simplicity.

According to the technical scheme, additional number of, i.e. redundant, synchronization slot resources are included in the synchronization resource of the terminal device, so that the terminal device may send the synchronization signal by occupying a part of or all of the N synchronization slots, which helps the terminal device to determine whether to use the synchronization resource for sending the synchronization signal according to a result of channel access, and further helps to support multiple terminal devices to send synchronization signals on one synchronization resource, thereby improving the reliability and the completeness of the synchronization mechanism of a sidelink, and improving the system performance.

Those of ordinary skill in the art may be aware that the units and algorithm steps in the examples described with reference to the embodiments disclosed in this specification can be implemented by electronic hardware or a combination of computer software and electronic hardware. Whether the functions are performed by hardware or software depends on particular applications and design constraints of the technical solutions. A person skilled in the art may realize the described functions for each particular disclosure by different methods, but it is not considered that the implementation is beyond the scope of the disclosure.

It may be clearly understood by a person skilled in the art that, for the purpose of convenient and brief description, for a detailed working process of the foregoing system, apparatus, and unit, reference may be made to a corresponding process in the foregoing method embodiments, and details are not described again herein.

In the several embodiments provided in the disclosure, it is to be understood that the disclosed system, apparatus, and method may be implemented in other modes. For example, the apparatus embodiment described above is only schematic, and for example, division of the units is only logic function division, and other division manners may be adopted during practical implementation. For example, multiple units or components may be combined or integrated into another system, or some characteristics may be neglected or not executed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate components may or may not be physically separated, and the components displayed as units may or may not be physical units, and may be located in one place or may be distributed over multiple network units. Some or all of the units may be selected according to actual needs to achieve the objectives of the solutions of the embodiments.

In addition, functional units in various embodiments of the disclosure may be integrated into one processing unit, or each of the units may be physically separated, or two or more units may be integrated into one unit.

When the functions are realized in a form of a software functional unit and sold or used as an independent product, they may be stored in a computer-readable storage medium. Based on this understanding, the technical solutions of the embodiments of the disclosure essentially or the parts that contribute to the prior art, or part of the technical solutions can be embodied in the form of a software product. The computer software product is stored in a storage medium, including multiple instructions for causing a computer device (which may be a personal computer, a server, or a network device, and the like) to execute all or part of the steps of the method described in the embodiments of the disclosure. The foregoing storage medium includes a USB flash disk, a mobile hard disk drive, an ROM, an RAM, and various media that can store program codes, such as a magnetic disk or an optical disk.

The above descriptions are merely specific implementations of the disclosure, but are not intended to limit the scope of protection of the disclosure. Any variation or replacement readily figured out by a person skilled in the art within the technical scope disclosed in the disclosure shall fall within the scope of protection of the disclosure. Therefore, the scope of protection of the disclosure is defined by the scope of protection of the claims.

1. A method for wireless communication, comprising:
determining, by a terminal device, a synchronization resource of a sidelink, wherein the synchronization resource comprises N synchronization slots, and N is a positive integer; and
sending, by the terminal device according to a result of performing channel access on the synchronization resource, a synchronization signal by occupying at least part of synchronization slots among the N synchronization slots.

2. The method of claim 1, wherein sending, by the terminal device according to the result of performing the channel access on the synchronization resource, the synchronization signal by occupying the at least part of synchronization slots among the N synchronization slots comprises:
determining, by the terminal device according to a result of channel access for an i-th synchronization slot among the N synchronization slots, whether to send the synchronization signal on the i-th synchronization slot, where i is a positive integer less than or equal to N.

3. The method of claim 2, wherein determining, by the terminal device according to the result of the channel access for the i-th synchronization slot among the N synchronization slots, whether to send the synchronization signal on the i-th synchronization slot comprises:
in a case where the result of the channel access indicates that a channel for the i-th synchronization slot is available, determining, by the terminal device, to send the synchronization signal on the i-th synchronization slot;
in a case where the result of the channel access indicates that the channel for the i-th synchronization slot is not available, determining, by the terminal device, not to send the synchronization signal on the i-th synchronization slot.

4. The method of claim 1, wherein sending, by the terminal device according to the result of performing the channel access on the synchronization resource, the synchronization signal by occupying the at least part of synchronization slots among the N synchronization slots comprises:
determining, by the terminal device according to a result of channel access for an i-th synchronization slot among the N synchronization slots, whether to send the synchronization signal on the i-th synchronization slot and on L synchronization slots located after the i-th synchronization slot in the synchronization resource, where i and L are positive integers less than or equal to N, and (i+L)≤N.

5. The method of claim 4, wherein determining, by the terminal device according to the result of the channel access for the i-th synchronization slot among the N synchronization slots, whether to send the synchronization signal on the i-th synchronization slot and on the L synchronization slots located after the i-th synchronization slot in the synchronization resource comprises:
in a case where the result of the channel access indicates that a channel for the i-th synchronization slot is available, determining, by the terminal device, to send the synchronization signal on the i-th synchronization slot and on the L synchronization slots;
in a case where the result of the channel access indicates that the channel for the i-th synchronization slot is not available, determining, by the terminal device, not to send the synchronization signal on the i-th synchronization slot.

6. The method of claim 4, wherein determining, by the terminal device according to the result of the channel access for the i-th synchronization slot among the N synchronization slots, whether to send the synchronization signal on the i-th synchronization slot and on the L synchronization slots located after the i-th synchronization slot in the synchronization resource comprises:
in a case where the result of the channel access obtained in a first channel access manner indicates that a channel for the i-th synchronization slot is available, determining to send the synchronization signal on the i-th synchronization slot; and
determining, according to a result of channel access for an (i+j)-th synchronization slot among the N synchronization slots in a second channel access manner, whether to send the synchronization signal on the (i+j)-th synchronization slot, where j is a positive integer less than or equal to N, and j≤L.

7. The method of claim 6, wherein determining, according to the result of the channel access for the (i+j)-th synchronization slot among the N synchronization slots in the second channel access manner, whether to send the synchronization signal on the (i+j)-th synchronization slot comprises:
in a case where the result of the channel access obtained in the second channel access manner indicates that a channel for the (i+j)-th synchronization slot is available, determining to send the synchronization signal on the (i+j)-th synchronization slot;
in a case where the result of the channel access obtained in the second channel access manner indicates that the channel for the (i+j)-th synchronization slot is not available, determining, by the terminal device, not to send the synchronization signal on the (i+j)-th synchronization slot.

8. The method of claim 6, wherein the first channel access manner comprises a first Listen Before Talk (LBT) manner, and the second channel access manner comprises a second LBT manner, a duration of the first LBT manner being longer than a duration of the second LBT.

9. The method of claim 1, wherein N has a value range of {1, . . . , 1024}.

10. A terminal device, comprising:
a processor, configured to determine a synchronization resource of a sidelink, wherein the synchronization resource comprises N synchronization slots, and N is a positive integer; and
a transceiver, configured to send, according to a result of performing channel access on the synchronization resource, a synchronization signal by occupying at least part of synchronization slots among the N synchronization slots.

11. The terminal device of claim 10, wherein the transceiver is specifically configured to:
determine, according to a result of channel access for an i-th synchronization slot among the N synchronization slots, whether to send the synchronization signal on the i-th synchronization slot, where i is a positive integer less than or equal to N.

12. The terminal device of claim 11, wherein the transceiver is specifically configured to:
in a case where the result of the channel access indicates that a channel for the i-th synchronization slot is available, determine to send the synchronization signal on the i-th synchronization slot;
in a case where the result of the channel access indicates that the channel for the i-th synchronization slot is not available, determine not to send the synchronization signal on the i-th synchronization slot.

13. The terminal device of claim 10, wherein the transceiver is specifically configured to:
determine, according to a result of channel access for an i-th synchronization slot among the N synchronization slots, whether to send the synchronization signal on the i-th synchronization slot and on L synchronization slots located after the i-th synchronization slot in the synchronization resource, where i and L are positive integers less than or equal to N, and (i+L)≤ N.

14. The terminal device of claim 13, wherein the transceiver is specifically configured to:
in a case where the result of the channel access indicates that a channel for the i-th synchronization slot is available, determine to send the synchronization signal on the i-th synchronization slot and on the L synchronization slots;
in a case where the result of the channel access indicates that the channel for the i-th synchronization slot is not available, determine not to send the synchronization signal on the i-th synchronization slot.

15. The terminal device of claim 13, wherein the transceiver is specifically configured to:
in a case where the result of the channel access obtained in a first channel access manner indicates that a channel for the i-th synchronization slot is available, determine to send the synchronization signal on the i-th synchronization slot; and
determine, according to a result of channel access for an (i+j)-th synchronization slot among the N synchronization slots in a second channel access manner, whether to send the synchronization signal on the (i+j)-th synchronization slot, where j is a positive integer less than or equal to N, and j≤ L.

16. The terminal device of claim 15, wherein the transceiver is specifically configured to:
in a case where the result of the channel access obtained in the second channel access manner indicates that a channel for the (i+j)-th synchronization slot is available, determine to send the synchronization signal on the (i+j)-th synchronization slot;
in a case where the result of the channel access obtained in the second channel access manner indicates that the channel for the (i+j)-th synchronization slot is not available, determine not to send the synchronization signal on the (i+j)-th synchronization slot.

17. The terminal device of claim 15, wherein the first channel access manner comprises a first Listen Before Talk (LBT) manner, and the second channel access manner comprises a second LBT manner, a duration of the first LBT manner being longer than a duration of the second LBT.

18. The terminal device of claim 10, wherein N has a value range of {1, . . . , 1024}.

19. A network device, comprising:
a transceiver, configured to send configuration information to a terminal device, wherein the configuration information is used for configuring the terminal device to send a synchronization signal by occupying at least part of synchronization slots among N synchronization slots in a synchronization resource, where N is a positive integer.

20. The network device of claim 19, wherein N has a value range of {1, . . . , 1024}.
